(19) United States
(12) Patent Application Publication
(10) Pub. No.: US 2024/0284197 A1
(43) Pub. Date: Aug. 22, 2024

(54) LINK PARAMETER RECOMMENDATION IN A WIRELESS LOCAL AREA NETWORK

(71) Applicant: QUALCOMM Incorporated, San Diego, CA (US)

(72) Inventors: Alfred Asterjadhi, San Diego, CA (US); Abhishek Pramod Patil, San Diego, CA (US); Gaurang Naik, San Diego, CA (US); George Cherian, San Diego, CA (US); Sai Yiu Duncan Ho, San Diego, CA (US); Yanjun Sun, San Diego, CA (US); Abdel Karim Ajami, Lakeside, CA (US)

(21) Appl. No.: 18/110,742

(22) Filed: Feb. 16, 2023

(51) Int. Cl. H04W 24/02; H04W 24/08

(52) U.S. Cl. CPC H04W 24/02; H04W 24/08

(57) ABSTRACT

This disclosure provides methods, components, devices and systems for link parameter recommendation in a wireless local area network. A first and second wireless communication device may communicate via one or more links. The second wireless communication device may use a first set of communication parameters to communicate with the first wireless communication device, and the first wireless communication device may determine that communication with the second wireless communication device using the first set of communication parameters fails to satisfy one or more criteria. Responsive to the determination, the first wireless communication device may transmit an indication for the second wireless communication device to use a second set of communication parameters for communicating with the first wireless communication device after which the first and second wireless communication device may communicate one or more frames.

### TECHNICAL FIELD

This disclosure relates generally to wireless communication, and more specifically, to link parameter recommendation in a wireless local area network (WLAN).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a device, such as an AP or a non-AP (e.g., a non-AP STA) may communicate with another device via one or more links. Devices that support communication via multiple links may be referred to as multi-link devices (MLDs).

### SUMMARY

The systems, methods and devices of this disclosure each have several innovative aspects, no single one of which is solely responsible for the desirable attributes disclosed herein.

One innovative aspect of the subject matter described in this disclosure can be implemented in a first wireless communication device. The first wireless communication device includes a processor and memory coupled with the processor. The processor and memory are operable to cause the first wireless communication device to monitor communication with a second wireless communication device via one or more links between the first wireless communication device and the second wireless communication device, the second wireless communication device using a first set of communication parameters for communicating with the first wireless communication device, transmit, to the second wireless communication device responsive to a determination that the communication using the first set of communication parameters fails to satisfy one or more criteria, an indication for the second wireless communication device to use a second set of communication parameters for communicating with the first wireless communication device, the second set of communication parameters being different from the first set of communication parameters, and communicate one or more frames with the second wireless communication device subsequent to transmitting the indication.

Another innovative aspect of the subject matter described in this disclosure can be implemented in a method for wireless communication at a first wireless communication device. The method includes monitoring communication with a second wireless communication device via one or more links between the first wireless communication device and the second wireless communication device, the second wireless communication device using a first set of communication parameters for communicating with the first wireless communication device, transmitting, to the second wireless communication device responsive to a determination that the communication using the first set of communication parameters fails to satisfy one or more criteria, an indication for the second wireless communication device to use a second set of communication parameters for communicating with the first wireless communication device, the second set of communication parameters being different from the first set of communication parameters, and communicating one or more frames with the second wireless communication device subsequent to transmitting the indication.

In some examples, to transmit the indication, the method and first wireless communication device may further include operations, features, means, or instructions for transmitting a frame that includes a recommendation that the second wireless communication device use the second set of communication parameters to communicate with the first wireless communication device.

In some examples, to transmit the indication, the method and first wireless communication device may further include operations, features, means, or instructions for transmitting a request for the second wireless communication device to adjust the first set of communication parameters, the second set of communication parameters being the adjusted first set of communication parameters.

In some examples, to transmit the indication, the method and first wireless communication device may further include operations, features, means, or instructions for transmitting a request for the second wireless communication device to activate one or more links for communicating with the first wireless communication device using the second set of communication parameters, the request comprising the second set of communication parameters.

In some examples, to transmit the indication, the method and first wireless communication device may further include operations, features, means, or instructions for transmitting a frame including a set of bits, each bit of the set of bits mapping to a respective set of communication parameters for the second wireless communication device to use for communicating with the first wireless communication device or to a respective set of adjustments to the first set of communication parameters, the indication being for the second wireless communication device to use the second set of communication parameters in accordance with a value of a first bit of the set of bits that maps to the second set of communication parameters or to a first set of adjustments to the first set of communication parameters used to generate the second set of communication parameters.

Another innovative aspect of the subject matter described in this disclosure can be implemented in a second wireless communication device. The second wireless communication device includes a processor and memory coupled with the processor. The processor and memory are operable to cause the second wireless communication device to communicate with a first wireless communication device using a first set of communication parameters, receive, from the first wireless communication device responsive to a determination that the communicating using the first set of communication parameters fails to satisfy one or more criteria, an indication for the second wireless communication device to use a second set of communication parameters for communicating with the first wireless communication device, and communicate one or more frames with the first wireless communication device subsequent to receiving the indication.

Another innovative aspect of the subject matter described in this disclosure can be implemented in a method for wireless communication at a second wireless communication device. The method includes communicating with a first wireless communication device using a first set of communication parameters, receiving, from the first wireless communication device responsive to a determination that the communicating using the first set of communication parameters fails to satisfy one or more criteria, an indication for the second wireless communication device to use a second set of communication parameters for communicating with the first wireless communication device, and communicating one or more frames with the first wireless communication device subsequent to receiving the indication.

In some examples, to receive the indication, the method and first wireless communication device may further include operations, features, means, or instructions for receiving a frame that includes a recommendation that the second wireless communication device use the second set of communication parameters to communicate with the first wireless communication device.

In some examples, to receive the indication, the method and first wireless communication device may further include operations, features, means, or instructions for receiving a request for the second wireless communication device to adjust the first set of communication parameters, the second set of communication parameters being the adjusted first set of communication parameters.

In some examples, to receive the indication, the method and first wireless communication device may further include operations, features, means, or instructions for receiving a request for the second wireless communication device to activate one or more links for communicating with the first wireless communication device using the second set of communication parameters, the request comprising the second set of communication parameters.

In some examples, to receive the indication, the method and first wireless communication device may further include operations, features, means, or instructions for receiving a frame including a set of bits, each bit of the set of bits mapping to a respective set of communication parameters for the second device to use for communicating with the first device or to a respective set of adjustments to the first set of communication parameters, the indication being for the second device to use the second set of communication parameters based at least in part on a value of a first bit of the set of bits that maps to the second set of communication parameters or to a first set of adjustments to the first set of communication parameters used to generate the second set of communication parameters.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point and one or more wireless stations.

FIG. 3 illustrates an example of a communication diagram that illustrates communications via one or more links between wireless devices to support link parameter recommendation in a wireless local area network (WLAN).

FIG. 4 illustrates an example of a frame diagram that illustrates a frame communicated between wireless devices to support link parameter recommendation in a WLAN.

FIGS. 5 and 6 illustrate examples of process flows showing operations performed by wireless devices to support link parameter recommendation in a WLAN.

FIG. 7 shows a flowchart illustrating an example process performable by a wireless communication device that supports link parameter recommendation in a WLAN.

FIG. 8 shows a flowchart illustrating an example process performable by a wireless communication device that supports link parameter recommendation in a WLAN.

FIG. 9 shows a block diagram of an example wireless communication device that supports link parameter recommendation in a WLAN.

FIG. 10 shows a block diagram of an example wireless communication device that supports link parameter recommendation in a WLAN.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless communication and more particularly to link parameter recommendations. Some aspects more specifically relate to a first wireless communication device recommending (such as indicating, requesting) parameters for a second wireless communication device to use to communicate with the first wireless communication device via one or more links. For example, the second wireless communication device, such as a non-access point (AP) multi-link device (MLD), may use a first set of communication parameters (such as a bandwidth, a number N_{SS} of spatial streams, a modulation and coding scheme (MCS), a mode of operation, among others) to communicate with the first wireless communication device, such as an AP MLD, via one or more links. The AP MLD may determine that communication with the non-AP MLD using the first set of communication parameters is sub-optimal, such as due to the communication failing to satisfy one or more criteria. In some examples, in response to the determination, the AP MLD may indicate a second set of communication parameters for the non-AP MLD to use to communicate with the AP MLD. In some examples, the AP MLD may request for the non-AP MLD to adjust the non-AP MLD's parameter selection (such as to expand or contract the non-AP MLD's operation), and the non-AP MLD may determine how to adjust the first set of communication parameters in accordance with the request (such as in accordance with constraints of the non-AP MLD).

The non-AP MLD may support various responses to the AP MLD's indication or request. In some examples, the non-AP MLD may explicitly indicate a decision to follow or reject the AP MLD's indication or request. In some examples, the non-AP MLD may ignore the AP MLD's indication or request or implicitly provide the decision depending on whether updated parameters are used by the non-AP MLD to communicate with the AP MLD. In some examples, the non-AP MLD may exchange additional frames with the AP MLD to negotiate a final parameter set to use for communicating with the AP MLD. The AP MLD and the non-AP MLD may subsequently communicate frames in accordance with the non-AP MLD's response.

Particular aspects of the subject matter described in this disclosure can be implemented to realize one or more of the following potential advantages. In some examples, by supporting a first wireless communication device to recommend one or more adjustments to parameters used by a second wireless communication device to communicate with the first wireless communication device, the described techniques can be used to increase reliability, reduce latency, increase throughput, and increase resource usage efficiency, among other benefits. For example, the first wireless communication device may dynamically recommend parameter adjustments to the second wireless communication device in accordance with current link conditions and/or device capabilities such that reliability, latency, throughput, or a combination thereof, can be improved. Such improvements to reliability, latency, and/or throughput may increase resource usage efficiency on the one or more links for which parameter the adjustments are made.

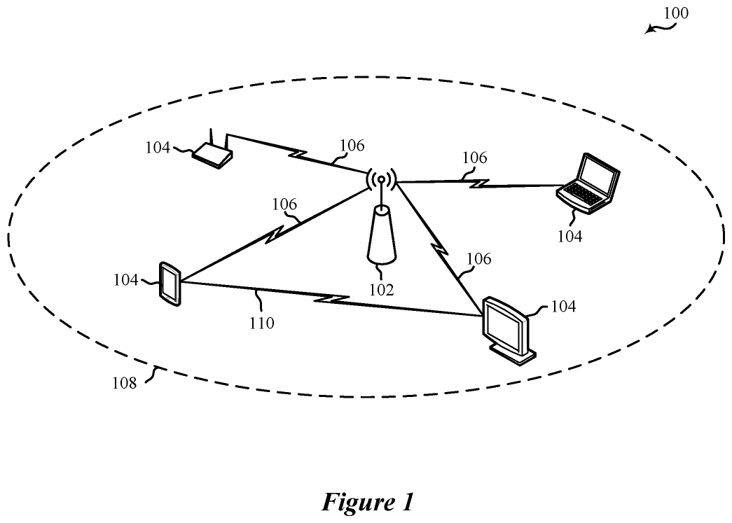

FIG. 1 shows a pictorial diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the physical layer (PHY) and MAC layer. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHZ and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

Some wireless communication devices (including both APs 102 and STAs 104) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

In some cases, communications between wireless communication devices, such as between an AP MLD and a non-AP MLD (among other combinations of the devices described herein) may be sub-optimal for current link conditions. For example, a first wireless communication device, such as an AP MLD, may communicate with a second wireless communication device, such as a non-AP MLD, via one or more links. The second wireless communication device may use a first set of communication parameters, such as selected by the second wireless communication device, to communicate with the first wireless communication device. The first wireless communication device may determine that usage of the first set of communication parameters is sub-optimal, such as due to communication with the second wireless communication device failing to satisfy one or more criteria. In response to the determination, the first wireless communication device may recommend (such as indicate or request) one or more adjustments to the parameters used by the second wireless communication device, such as based on the current link conditions and/or capabilities of the second wireless communication device, to improve the communication between the first and second wireless communication devices. In some examples, the first wireless communication device may recommend (such as indicate) a second set of communication parameters for the second wireless communication device to use to communicate with the first wireless communication device, to improve the communication between the first and second wireless communication devices.

The second wireless communication device may support various responses to the first wireless communication device's recommendation. In some examples, the second wireless communication device may explicitly indicate a decision to follow or reject the first wireless communication device's indication or request. In some examples, the second wireless communication device may ignore the first wireless communication device's indication or request or implicitly provide the decision depending on whether updated parameters are used by the second wireless communication device to communicate with the first wireless communication device. In some examples, the second wireless communication device may exchange additional frames with the first wireless communication device to negotiate a final parameter set to use for communicating with the first wireless communication device. The first wireless communication device and the second wireless communication device may subsequently communicate frames in accordance with the second wireless communication device's response.

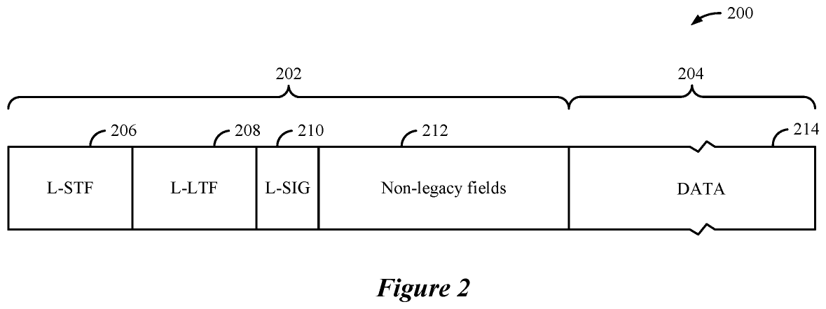

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some examples, a first wireless communication device may recommend communication parameters for a second wireless communication device to use to communicate a PDU 200 such that reliability, latency, throughput, or a combination thereof, associated with communicating the PDU 200 may be improved. For example, the first wireless communication device may indicate an updated set of parameters for the second wireless communication device to use to communicate a PDU 200 via one or more links between the devices. Alternatively, the first wireless communication device may request for the second wireless communication device to adjust the second wireless communication device's parameter selection (such as to expand or contract its operation) for communicating PDUs 200, and the second wireless communication device may determine how to adjust (such as update) parameters used by the second wireless communication device in accordance with the request. As such, in accordance with how the parameters are updated (such as in accordance with current link conditions), latency, throughput, and/or reliability associated with communicating one or more PDUs 200 may be improved.

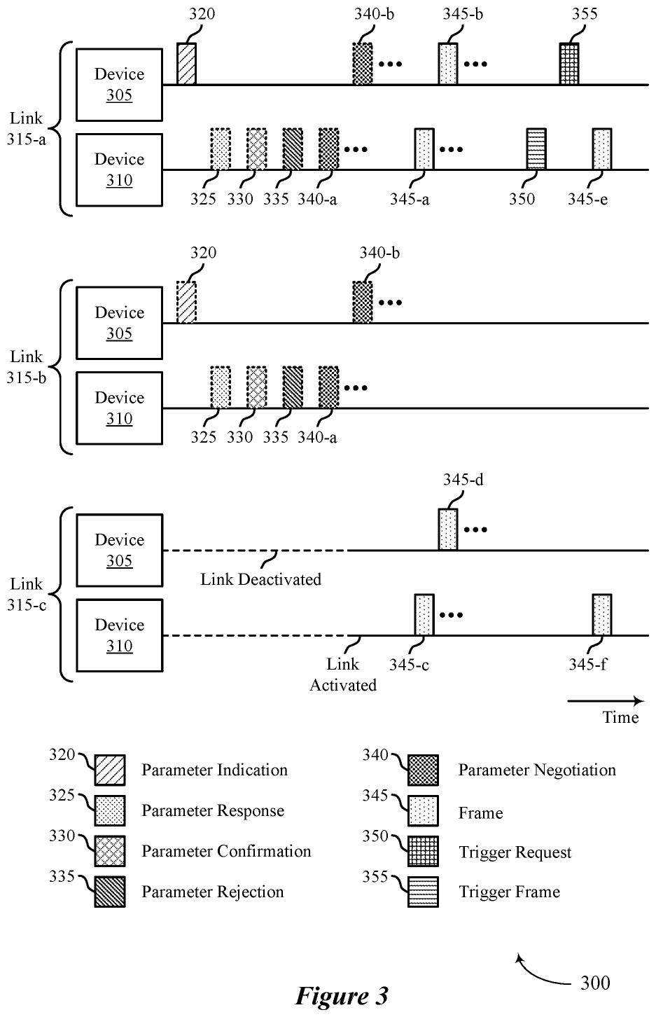

FIG. 3 illustrates an example of a communication diagram 300 that illustrates communications via one or more links between wireless devices to support link parameter recommendation in a WLAN. The communication diagram 300 may be implemented by aspects of the WLAN 100. For example, the communication diagram 300 illustrates communications between a device 305 and a device 310, which may be examples of wireless communication devices described herein, including with reference to FIGS. 1 through 2. For example, the device 305 may be an example of an AP 102, an MLD, an AP STA (such as a STA 104), a non-AP MLD, or a non-AP STA (such as a STA 104). Additionally, the device 310 may be an example of an AP MLD, a non-AP MLD, an AP STA, or a non-AP STA.

The device 305 and the device 310 may communicate via one or more links 315. For example, the device 305 and the device 310 may be MLDs that support concurrently communicating via multiple links 315, which may be examples of communication links 106 described with reference to FIG. 1. Alternatively, the device 305 or the device 310 or both may be single link devices that support communicating via one link 315 at a time. In the example of FIG. 3, the device 305 and the device 310 may be MLDs that support communication via a link 315-a, a link 315-b, and a link 315-c (however any quantity of links 315 may be support by the device 305 and the device 310).

The device 310 may use various parameters to communicate with the device 305. For example, the device 310 may use a first set of communication parameters to communicate with the device 305, the first set of communication parameters including at least one of a bandwidth used by the device 310, a number N_{SS} of spatial streams used by the device 310, an MCS used by the device 310, a mode of operation according to which the device 310 operates, a TID-to-link mapping used by the device 310, a type of PPDU used by the device 310, or any combination thereof. In some examples, the TID-to-link mapping may be a mapping between respective TIDs and links 315. For example, a first TID may be mapped to a first link 315 (such as the link 315-a), a second TID may be mapped to a second link 315 (such as the link 315-b), and so on such that traffic associated with a given TID may be communicated (such as only) via the corresponding link 315.

In some examples, the parameters used by the device 310 to communicate with the device 305 may be managed by the device 310. For example, the device 310 may transmit one or more OMIs or operating mode notifications (OMNs) to select (such as indicate, recommend, request) the first set of communication parameters for use in communicating with the device 305. In some examples, the device 310 may use the first set of communication parameters for communications across multiple links 315 or may use respective sets of parameters for respective communications via respective links 315.

In some cases, the device 305 may determine, for example using one or more machine learning techniques, that the first set of communication parameters used by the device 310 are sub-optimal for communicating with the device 305 in accordance with current link conditions (such as channel conditions) and/or one or more capabilities of the device 305. For example, the device 305 may monitor communications with the device 310 via one or more of the links 315 and determine that the communications fail to satisfy one or more criteria. For instance, the device 305 may monitor communications via the link 315-a and determine that the communications by the device 310 using the first set of communication parameters fails to satisfy the one or more criteria. For example, the device 305 may include (such as implement) a machine learning model to determine a bandwidth configuration for use by the second wireless communication device with the first wireless communication device based on the link conditions between the first and the second wireless communication devices.

Various criteria are possible, such as corresponding to various communication characteristics. For example, reliability criteria, latency criteria, throughput criteria, communication range criteria, or combinations thereof, among others, may be used to determine whether the communications using the first set of communication parameters are sub-optimal and whether these communication characteristics may be improved by adjusting (such as modifying, changing) the first set of communication parameters, such as in accordance with link conditions and/or capabilities of the device 310. For instance, one or more message failures, relatively low signal quality, repeated retransmissions, and the like, may indicate a failure to satisfy a reliability criteria. Additionally or alternatively, relatively lower transmission rates when link conditions are good (such as when signal quality satisfies a threshold) may indicate a failure to satisfy latency and/or throughput criteria. It is noted that these examples or non-limiting and that other criteria and triggering conditions for failing to satisfy criteria are possible.

Responsive to the determination that the communications fail to satisfy the one or more criteria, the device 305 may recommend one or more parameter adjustments to the device 310. For example, the device 305 may transmit a parameter indication 320 indicating for the device 310 to use a second set of communication parameters for communicating with the device 305. In some examples, the device 305 may transmit the parameter indication 320 via a link 315 to which the usage of the second set of communication parameters applies (or for which the device 305 determined the failure to satisfy the one or more criteria), such as the link 315-a in the example of FIG. 3. In some examples, the device 305 may transmit the parameter indication via a different link 315, such as the link 315-b. For example, the link 315-b may be a more robust link relative to the link 315-a (such as the link 315-b being a 2.4 GHz link and the link 315-a being a 5 GHz link), and transmission of the parameter indication 320 via the link 315-b may increase a reliability of the transmission relative to transmitting the parameter indication 320 via the link 315-a.

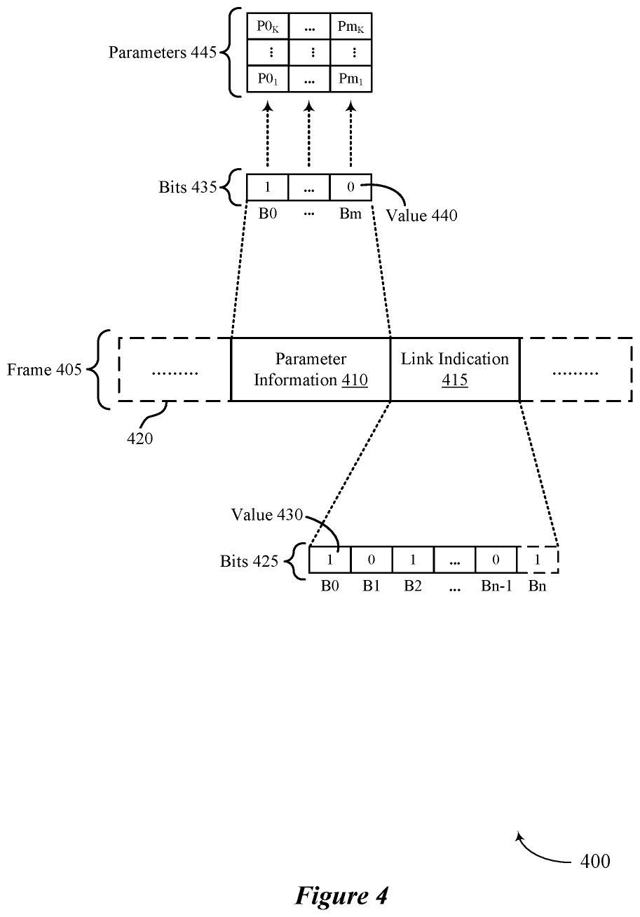

The parameter indication 320 may indicate usage of the second set of communication parameters by the device 310 according to various techniques. In some examples, the parameter indication 320 may indicate (such as explicitly) the second set of communication parameters that the device 305 recommends the device 310 to use. For example, the parameter indication 320 may be a frame that includes a recommendation that the device 310 use the second set of communication parameters indicated by the parameter indication 320 to communicate with the device 305. In some examples, the parameter indication 320 may include the second set of communication parameters. In some examples, the parameter indication 320 may indicate one or more specific adjustments to the first set of communication parameters that may be made to generate the second see of communication parameters. In some examples, the parameter indication 320 may indicate the second set of communication parameters based on one or more bits of the parameter indication 320 that map to the second set of communication parameters or to one or more adjustments to the first set of communication parameters that may be used to generate the second set of communication parameters, as described with reference to FIG. 4.

Alternatively, the parameter indication 320 may be a request for the device 310 to adjust the first set of communication parameters. Here, the second set of communication parameters may be the adjusted first set of communication parameters. That is, the parameter indication 320 may exclude an explicit indication of the second set of communication parameters for the device 310 to use. Instead, the parameter indication may include a request for how the first set of communication parameters are to be adjusted. For example, the request may request for the device 310 to expand or contract the operation of the device 310. For instance, to expand the operation of the device 310, the first set of communication parameters may be adjusted to increase a throughput of the device 310, reduce a latency of the device 310 communications, increase a reliability of the device 310 communications, or any combination thereof, among other adjustments to other communication characteristics. To contract the operation of the device 310, the first set of communication parameters may be adjusted to increase a reliability of the device 310 communications, among other adjustments to other communication characteristics.

The second set of communication parameters may include various parameters that may affect communications via the one or more links 315 to which the second set of communication parameters applies. For example, the second set of communication parameters may include a bandwidth for the device 310 to use, a number N_{SS} of spatial streams for the device 310 to use, an MCS for the device 310 to use, a first mode of operation to enable at the device 310 for communicating with the device 305, a second mode of operation to disable at the device 310 for communicating with the device 305, a TID-to-link mapping (such as an updated TID-to-link mapping) for the device 310 to use, a type of PPDU for the device 310 to use, or any combination thereof.

The first mode of operation and the second mode of operation may include an enhanced multi-link single radio (EMLSR) mode, an enhanced multi-link multi radio (EMLMR) mode, a multi-link multi-radio (MLMR) mode, a multi-link single radio (MLSR) mode, a multi-primary channel mode, spatial multiplexing power save mode, or a packet repetition mode, among other modes of operation according to which the device 310 may operate. The multi-primary channel mode may be a mode of operation in which multiple sub-channels (such as one or more 20 MHz, 10 MHZ, or 5 MHz subchannels) of a channel (such as a link 315) may operate as primary channels. The packet repetition mode may be a mode that indicates a repetition of a frame communicated on a link 315, such as including a quantity of repetitions of the frame. Additionally or alternatively, the packet repetition mode may be a mode that indicates (such as enables) a duplication of a frame across multiple links 315. In some examples, the mode indication the duplication of the frame may be referred to as a packet duplication mode.

The second set of communication parameters indicated by the device 305 or determined by the device 310 (such as the one or more adjustments to the first set of communication parameters) may be based on the communication characteristics to be improved. For example, the device 305 may indicate for the device 310 to increase the bandwidth, the number N_{SS} of spatial streams, the MCS, or a combination thereof, used by the device 310, such as to increase throughput and reduce latency, among other benefits. In some examples, the device 305 may indicate for the device 310 to reduce the bandwidth, the number N_{SS} of spatial streams, the MCS, or a combination thereof, used by the device 310, such as to increase reliability or reduce power consumption, among other benefits.

In some examples, the second set of communication parameters indicated by the device 305 may indicate specific values for one or more communication parameters, such as a 40 MHz bandwidth, two spatial streams, and the like. In some examples, the second set of communication parameters indicated by the device 305 may indicate adjustments relative to the first set of parameters, such as to double or half the bandwidth, increase or decrease the number N_{SS} of spatial streams by one, increase or decrease the MCS by one, and the like. In some examples, the second set of communication parameters indicated (such as requested) by the device 305 may be in accordance with a capability of the device 310. For example, the device 305 may indicate (such as request, recommend) for the device 310 to increase the first set of communication parameters to respective maximum possible values, such as one or more of a maximum bandwidth, number N_{SS} of spatial streams, or MCS supported by the device 310. Alternatively, the device 305 may indicate for the device 310 to decrease the first set of communication parameters to respective minimum possible values, such as one or more of a minimum bandwidth, number N_{SS} of spatial streams, or MCS supported by the device 310.

In some examples, the second set of communication parameters indicated by the device 305 may indicate for the device 310 to enable the first mode of operation, disable the second mode of operation, or a combination thereof. For example, the second set of communication parameters may indicate for the device 310 to disable operation according to the EMLSR mode and enable (such as switch to) the MLMR mode, such as to increase throughput and reliability on the links 315 to which the second set of communication parameters apply. In some examples, the second set of communication parameters may indicate for the device 310 to enable the multi-primary channel mode, such as to efficiently use under-utilized subchannels of one or more links 315 to which the second set of communication parameters apply. In some examples, the second set of communication parameters may indicate for the device 310 to enable the packet repetition mode, such as to increase reliability of the frames communicated in accordance with the packet repetition mode. In some examples, the second set of communication parameters may indicate for the device 310 to disable the packet repetition mode, such as to reduce power consumption, reduce latency, or increase throughput, among other benefits.

In some examples, the second set of communication parameters may indicate a TID-to-link mapping (such as an updated TID-to-link mapping) according to which the device 310 may communicate traffic via respective links 315. For example, the TID-to-link mapping may indicate for higher priority traffic to be communicated via links 315 for which link conditions are better relative to links 315 via which lower priority traffic is to be communicated in accordance with the TID-to-link mapping.

In some examples, the second set of communication parameters may indicate for the device 310 to adjust a type of PPDU transmitted by the device 310 to the device 305. For example, the second set of communication parameters may indicate for the device 310 to use a high efficiency (HE) extended range (ER) PPDU for communicating with the device 305 to increase a range and reliability of the communications with the device 305.

In some examples, the second set of communication parameters may indicate for the device 310 to adjust a bandwidth or number N_{SS} of spatial streams used by the device 305 in accordance with a usage of the device 305. For example, if the device 305 uses or will use a reduced bandwidth or number N_{SS} of spatial streams to communicate with the device 310, the second set of communication parameters may indicate for the device 310 to reduce the bandwidth or number N_{SS} of spatial streams, such as to increase reliability or conserve power at the device 310.

If the parameter indication 320 includes the request to expand or contract the operation of the device 310 and the device 310 follows (such as adheres to, adjusts parameters in accordance with) the request, the device 310 may determine the adjustments to the first set of communication characteristics that align with the request, such as in accordance with operating constraints of the device 310. For example, if the request is for the device 310 to expand its operation and the device 310 is under operating constraints, such as a power consumption constraint, the device 310 may determine to increase a bandwidth, number N_{SS} of spatial streams, MCS, or a combination thereof, used by the device 310 on one or more already active links 315 rather than activating one or more additional links 315, which may be associated with increased power consumption. As such, the device 310 may expand its operation in accordance with the request while maintaining operation within the operating constraints of the device 310.

The parameter recommendation by the device 305 may be indicated in conjunction with a link recommendation. For example, the device 305 may transmit the parameter indication 320 including a request for the device 310 to activate one or more links 315 for communicating with the device 305 using the second set of communication parameters (such as indicated via the parameter indication 320 or determined by the device 310 as requested by the parameter indication 320). For instance, the parameter indication 320 may request for the device 310 to activate the link 315-c to communicate with the device 305 and for the device 310 to use the second set of communication parameters to communicate with the device 305 via the link 315-c. In an example, the parameter indication 320 may request for the device 310 to activate (such as wake up on) the link 315-c with a maximum bandwidth, number N_{SS} of spatial streams, MCS, or any combination thereof, supported by the device 310. In some examples, if the device 310 follows the request, the device 310 may activate the link 315-c and indicate (such as via a parameter response 325) the highest bandwidth, number N_{SS} of spatial streams, MCS, or any combination thereof, that the device 310 may use on the link 315-c (such as via OMI or OMN).

It is noted that the parameter adjustments described herein are provided as non-limiting examples and that any combination of adjustments to any of the communication parameters may be recommended by the device 305 or determined by the device 310 in accordance with a request by the device 305 to improve communications between the device 305 and the device 310 via one or more links 315.

The parameter indication 320 may include an indication as to which links 315 to the parameter indication 320 applies. For example, the indication may indicate for which links 315 the device 310 is to use the second set of communication parameters to communicate with the device 305, as described with reference to FIG. 4. In some examples, the device 305 may transmit a respective parameter indication 320 indicating a respective second set of communication parameters for the second device 310 to use for communicating via a respective link 315 indicated by the parameter indication 320.

The device 310 may support various responses to the parameter indication 320. For example, if requested to adjust the first set of communication parameters (such as expand or contract the operation of the device 310) the device 310 may determine the adjusted first set of communication parameters (such as the second set of communication parameters). In some examples, the device 310 may transmit a parameter response 325 to the device 305 (such as via the link 315-a or the link 315-b) that indicates the second set of communication parameters. In accordance with the parameter response 325, the device 305 and the device 310 may communicate one or more frames 345 (such as frames 345-a and 345-b via the link 315-a, frames 345-c and 345-d via the activated link 315-c, among other frames 345 that may be communicated via the links 315) in accordance with the second set of communication parameters. That is, the device 310 may use the second set of communication parameters to communicate the one or more frames 345.

In some examples, the device 310 may omit transmission of a parameter response 325 and may instead begin using (such as operating in accordance with) the second set of communication parameters. Here, communication in accordance with the second set of communication parameters may serve as an implicit indication to the device 305 that the device 310 adhered to (such as complied with, followed, executed, operated according to) the request. That is, the device 310 communicating with the device 305 using the second set of communication parameters may implicitly indicate to the device 305 that the device 310 has complied with the request.

In some examples, the device 310 may explicitly indicate whether the device 310 adheres to the indicated (such as recommended) second set of communication parameters. For example, the device 310 may transmit a parameter confirmation 330 (such as via the link 315-a or the link 315-b) that confirms a usage of the second set of wireless communication parameters by the device 310. For instance, if the parameter indication 320 indicates for the device 310 to increase a number N_{SS} of spatial streams on one or more links 315 and the device 310 complies with the parameter indication 320 to increase the number N_{SS} of spatial streams, the device 310 may transmit the parameter confirmation 330 confirming the increase of the number N_{SS} of spatial streams on the one or more links 315. Alternatively, the device 310 may transmit a parameter rejection 335 (such as via the link 315-a or the link 315-b) that indicates a rejection by the device 310 to use the second set of communication parameters. For instances, if the parameter indication 320 indicates for the device 310 to increase a bandwidth on one or more links 315 and the device 310 rejects the parameter indication 320 and does not increase the bandwidth, the device 310 may transmit the parameter rejection 335 to indicate that the device 310 will not increase the bandwidth on the one or more links 315.

In some examples, the device 310 may omit transmission of a parameter confirmation 330 or a parameter rejection 335. Instead, communication by the device 310 in accordance with the second set of communication parameters or the first set of communication parameters may implicitly indicate to the device 305 whether the device 310 confirms or rejects the parameter indication 320. For example, continued use of the first set of communication parameters after the transmission of the parameter indication 320 may indicate that the device 310 rejects or ignores the parameter indication 320. Alternatively, switching to using the second set of communication parameters after the transmission of the parameter indication 320 may indicate that the device confirms (such as complies with, adheres to) the parameter indication 320.

In some examples, the device 305 and the device 310 may perform a negotiation procedure to negotiate a final set of updated parameters for use by the device 310 to communicate with the device 305. For example, in response to the parameter indication 320, if the device 310 rejects one or more of the second set of communication parameters, the device 310 may transmit a parameter negotiation 340-a (such as via the link 315-a or the link 315-b) that indicates a third set of communication parameters for the device 310 to use to communicate with the device 305, which may include at least one or more communication parameters that are different relative to the second set of communication parameters. In response to the parameter negotiation 340-a, the device 305 may transmit a parameter negotiation 340-b (such as via the link 315-a or the link 315-b). If the device 305 accepts the third set of communication parameters for use by the device 310, the parameter negotiation 340-b may include a confirmation of the third set of communication parameters for use by the device 310, and the device 305 and the device 310 may communicate one or more frame 345 in accordance with the third set of communication parameters.

Alternatively, if the device 305 rejects one or more of the third set of communication parameters for use by the device 310, the parameter negotiation 340-b may indicate a fourth set of communication parameters for the device 310 to use to communicate with the device 305, which may include at least one or more communication parameters that are different relative to the third set of communication parameters. If the device 310 accepts the fourth set of communication parameters, the device 310 may explicitly (such as via the transmission of another parameter negotiation 340 or a parameter confirmation 330) or implicitly indicate confirmation of the fourth set of communication parameters, and the device 305 and the device 310 may communicate one or more frames 345 in accordance with the fourth set of communication parameters. Otherwise, the negotiation may continue via the transmission of additional parameter negotiations 340, such as until a final (such as a fifth) set of communication parameters is agreed upon, and the devices 305 and 310 may communicate one or more frames 345 in accordance with the final (such as the fifth) set of communication parameters.

In some examples, the negotiation of the final set of communication parameters may be initiated by the device 305. For example, in response to the parameter response 325 that indicates the second set of communication parameters determined (such as selected) by the device 310, if the device 305 rejected one or more of the communication parameters determined by the device 310, the device 305 may transmit a parameter negotiation 340 to the device 310 to begin the negotiation of the final set of communication parameters.

The device 310 may support requesting to be triggered to transmit one or more frames 345 to the device 305 in accordance with a set of communication parameters. For example, the device 310 may transmit a trigger request 350 that requests for the device 305 to trigger the device 310 to transmit one or more frames 345 (such as frames 345-e or 345-f) to the device 305. The trigger request 350 may include a set of communication parameters associated with transmission of the one or more frames 345. For example, the set of communication parameters may be parameters with which the device 310 requests to be triggered to transmit the one or more frames 345. In some examples, the set of communication parameters may include one or more of the communication parameters described above. For example, the device 305 may be assigning a 40 MHz bandwidth for the communication of frames 345 triggered by the device 305. The device 310 may determine that additional bandwidth may enable the device 310 to flush (such as transmit) data (such as buffered data) to the device 305 faster, such as within the latency budget of the frames 345, and the set of communication parameters may thus request for an increased bandwidth. In some other examples, the device 310 may determine that a reduced bandwidth relative to the bandwidth that the device 305 is assigning may increase a reliability of the triggered frames 345, and the set of communication parameters may thus request for a reduced bandwidth. Other parameter requests for the triggered frames 345 by the device 310 are possible.

In some examples, the set of communication parameters may include an expectation of how soon the device 310 expects to be triggered. For example, the set of communication parameters may include a request to be triggered within a duration from the transmission of the trigger request 350. In some examples, the set of communication parameters may include a requested duration of the one or more frames 345 (such as trigger-based (TB) PPDUs). In some examples, the trigger request 350 may include an indication, such as a bitmap, of one or more links 315 to which the trigger request 350 corresponds, as described with reference to FIG. 4.

In response to the trigger request 350, the device 305 may transmit a trigger frame 355 that triggers the device 310 to transmit the one or more frames 345. The device 305 may consider the requested set of communication parameters while triggering the transmission of the one or more frames 345 by the device 310. For example, the device 305 may schedule the device 310 within the requested duration from the trigger request 350 to satisfy a packet delay budget of the device 310. That is, if possible in consideration of other traffic managed and communicated by the device 305, the device 305 may transmit the trigger frame 355 to trigger the transmission of the one or more frames 345 in accordance with the requested set of communication parameters. Accordingly, in some examples, the device 310 may use the requested set of communication parameters to transmit the one or more frames 345 to the device 305 in response to the trigger frame 355.

By supporting the request of communication parameters by the device 310 in association with trigger-based communications, the device 305 and the device 310 may increase a reliability, reduce a latency, increase a throughput, or a combination thereof, associated with the trigger-based communications. For example, the device 310 may intelligently request communication parameters for assignment by the device 310 when triggering the device 305 such that reliability, latency, throughput, or a combination thereof, may be improved.

FIG. 4 illustrates an example of a frame diagram 400 that illustrates a frame 405 communicated between wireless devices to support link parameter recommendation in a WLAN. The communication diagram 300 may be implemented by aspects of the WLAN 100. For example, the frame diagram 400 illustrates a frame 405 that may be communicated between wireless communication devices, such as between a device 305 and a device 310 described with reference to FIG. 3.

In some examples, the device 305 may transmit the frame 405 to indicate (such as recommend, request) for the device 310 to use an updated set of parameters to communicate with the device 305. For example, the frame 405 may be an example of a parameter indication 320 described with reference to FIG. 3. In some examples, the device 310 may transmit the frame 405 to request that the device 305 trigger the device 310 to transmit one or more frames (such as TB PPDUs) using a requested set of communication parameters. For example, the frame 405 may be an example of a trigger request 350 described with reference to FIG. 3.

The frame 405 may be communicated via various types of signaling. In some examples, the device 305 and the device 310 may communicate the frame via aggregated control (A-Control) signaling (such as via AP assistance request (AAR) signaling or its variant), a Block ACK frame, or an action frame (such as a MLO update request/response frame, a multi-link reconfiguration request/response, a link recommendation frame, or a newly defined action frame).

The frame 405 may include various information subfields via which various types of information may be communicated. For example, the frame 405 may include a subfield for indicating parameter information 410, a subfield for indicating a link indication 415, or both. In some examples, the frame 405 may include other subfields 420 via which other information included in the frame 405 may be communicated.

In some examples, the parameter information 410 may include a request for the device 310 to adjust a first set of communication parameters used by the device 310 to communicate with the device 305, such as to expand or contract the operation of the device 310. In some examples, the parameter information 410 may indicate a set of communication parameters 445 that the device 305 recommends for the device 310 to use to communicate with the device 305. In some examples, the parameter information 410 may indicate a set of communication parameters 445 with which the device 310 requests to be configured to transmit one or more trigger-based frames (such as TB PPDUs).

The parameter information 410 may include one or more bits 435. In some examples, if the parameter information 410 is a request for the device 310 to adjust the first set of communication parameters, the values 440 of the one or more bits 435 may indicate whether the request is for the device 310 is to expand or contract its operation. For example, a value 440 of ‘1’ of a bit 435 may indicate for the device 310 to expand its operation, while a value 440 of ‘0’ of a bit 435 may indicate for the device 310 to contract its operation.

In some examples, if the parameter information 410 indicates the set of communication parameters 445, the one or more bits 435 may indicate values for the parameters of the set of communication parameters, such as absolute values or adjustments relative to the first set of communication parameters as described with reference to FIG. 3. In some examples, each bit of the bits 435 may map to a respective set of communication parameters for the device 310 use for communicating with the device 305 or to a respective set of adjustments to the first set of communication parameters. For example, the quantity of potential parameter adjustments that may be indicated via the parameter information 410 may be large relative to the quantity of bits 435 available for the parameter information 410 within the frame 405. Accordingly, mappings of respective bits 435 to respective sets of communication parameters or parameter adjustments may support the indication of various combinations of updated parameters with reduced overhead, while being within the bit space constraints of the frame 405, or a combination thereof.

For example, a bit 435 B0 may map to a set of communication parameters P0₁ through P0_{K} or a set of parameter adjustments P0₁ through P0_{K}, and so on up through a bit 435 Bm mapping to a set of communication parameters Pm₁ through Pm_{K} or a set of parameter adjustments Pm₁ through Pm_{K}. A value 440 of the bits 435 may indicate whether a respective set of communication parameters or parameter adjustments is indicated by the parameter information 410. For example, a value 440 of ‘l’ of the bit 435 B0 may indicate that the set of communication parameters P0₁ through P0_{K} or the set of parameter adjustments P0₁ through P0_{K} are indicated by the parameter information 410 for use by the device 310, while a value 440 of ‘0’ of the bit 435 Bm may indicate that the set of communication parameters Pm₁ through Pm_{K} or the set of parameter adjustments Pm₁ through Pm_{K} are not indicated by the parameter information 410 for use by the device 310, or vice versa.

It is noted that the quantity of communication parameters or parameter adjustments mapped to by each bit 435 may be the same across the bits 435 or varied from bit 435 to bit 435. Additionally, in some examples, each bits 435 may map to a respective set of communication parameters or each bit 435 may map to a respective set of parameter adjustments. Alternatively, some bits 435 may map to respective sets of communication parameters, while other bits 435 may map to respective parameter adjustments.

In some examples, each bit of the bits 435 may similarly map to a respective set of communication parameters (such as P0₁ through P0_{K}) with which the device 310 requests to be configured to transmit the one or more trigger-based frames.

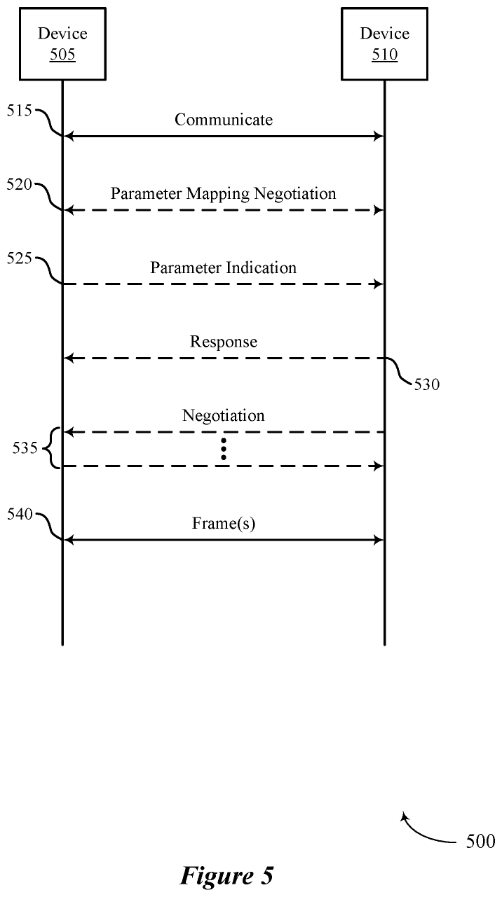

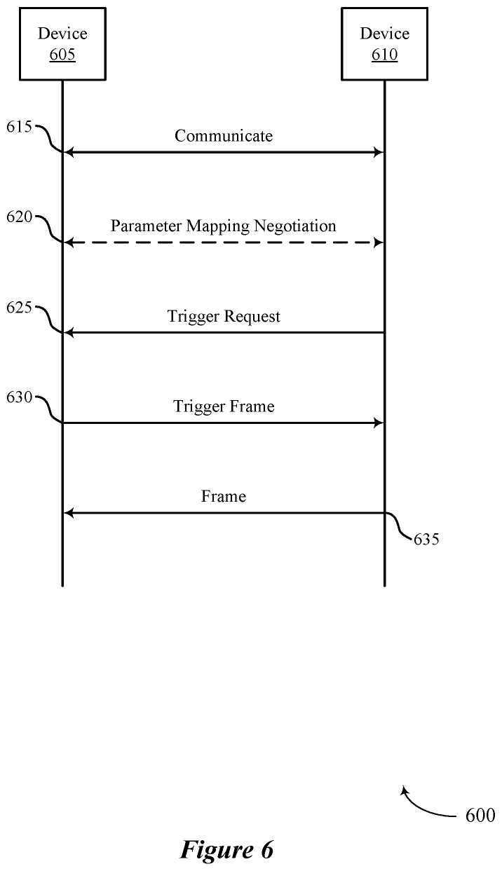

In some examples, the mapping of each bit to a respective set of communication parameters or set of parameter adjustments may be negotiated by the device 305 and the device 310, as described with reference to FIGS. 5 and 6. In some examples, the device 305 and the device 310 may determine whether to associate with each other based on a capability of the device 305 and the device 310 to negotiate the mapping. For example, in some cases, if the device 305 may refrain from establishing a link with the device 310 if the device 310 does not support the capability to negotiate the mapping, or vice versa. Similarly, if the device 310 does have the capability to negotiate the mapping, the device 305 may establish the link with the device 310, or vice versa.

The link indication 415 may indicate which links (such as links 315) to which to the frame 405 corresponds. For example, the link indication 415 may indicate which one or more links of a set of links between the devices 305 and 310 for which parameter information 410 applies, such as for which the device 310 is to use the communication parameters indicated by the parameter information 410.

In some examples, the link indication 415 may include a set of bits 425 (such as a bitmap) to indicate the one or more links of the set of links. For example, the bits 425 (such as the bitmap) may include bits B0 through Bn with each bit being associated with (corresponding to) a respective link of the set of links. Each bit 425 may indicate whether the parameter information 410 applies to the associated link (such as whether the device 310 is to use the communication parameters to communicate via the associated link). For example, the bit 425 B0 may correspond to a first link (such as the link 315-a) and indicate whether the device 310 is to use the communication parameters to communicate via the first link, the bit 425 B1 may correspond to a second link and indicate whether the device 310 is to use the communication parameters to communicate via the second link, and so on. The bits 425 may indicate whether the parameter information 410 applies to the associated link based on a value 430 of the bit 425. For example, a value 430 of ‘1’ may indicate that the parameter information 410 applies to the associated link, while a value 430 or ‘0’ indicate that the parameter information 410 does not apply to (such as is unassociated with) the associated link, or vice versa.

In some examples, the bits 425 may correspond to one or more link identifiers. For example, each link of the set of links may be associated with a respective link identifier, and the bits 425 may indicate one or more link identifiers for which the parameter information 410 applies to the associated links. Here, links excluded from those indicated by the bits 425 may be unassociated with the parameter information 410.

FIG. 5 illustrates an example of a process flow 500 showing operations performed by wireless devices to support link parameter recommendation in a WLAN. The process flow 500 may implement aspects of WLAN 100. For example, process flow 500 may be implemented by a device 505 and a device 510. The device 505 and the device 510 may be examples of the device 305 and the device 310, respectively, as described herein, including with reference to FIG. 3.

In the following description of process flow 500, the operations between the device 505 and the device 510 may be performed in a different order than the order shown, or other operations may be added or removed from the process flow 500. Specific operations may also be left out of the process flow 500 or may be performed in different orders or at different times. Although the device 505 and the device 510 are shown performing the operations of the process flow 500, some aspects of some operation may also be performed by one or more other wireless communication devices. Further, although some operations or signaling may be shown to occur at different times for discussion purposes, these operations may actually occur at the same time.

At 515, the device 505 and the device 510 may communicate via one or more links. For example, the device 510 may use a first set of communication parameters to communicate with the device 505, and the device 505 may monitor communication with the device 510 as to whether the communication fails to satisfy one or more criteria.

At 520, the device 505 and the device 510 may perform a parameter mapping negotiation to negotiate a mapping of bits to respective sets of communication parameters or sets of parameter adjustments, such as mappings to parameters 445 described with reference to FIG. 4. For example, the device 505 may support recommending for the device 510 to use a second set of communication parameters for communicating with the device 505, such as in response to a determination that the communication with the device 510 fails to satisfy the one or more criteria. In some examples, the device 505 may indicate the second set of communication parameters by indicating the second set of communication parameters or by indicating a set of parameter adjustments (such as relative to the first set of communication parameters or a capability of the device 510) such that the second set of communication parameters may be generated.

As described with reference to FIG. 4, to reduce signaling overhead, to recommend the second set of communication parameters within the bit constraints of a frame 405, or both, bits of a parameter indication (such as a parameter indication 320, a frame 405) may map to respective sets of communication parameters or parameter adjustments that may be recommended by the device 505. To support such mapping, the device 505 and the device 510 may communicate one or more frames to negotiate a respective mapping of each bit. For example, the device 505 and the device 510 may communicate the frames to recommend respective mappings for each bit to which the other device may confirm or reject the mapping. Frames may continue to be communicated until a final mapping for each of the bits is agreed upon by the device 505 and the device 510.

At 525, the device 505 may transmit a parameter indication to the device 510 to use the second set of communication parameters for communicating with the device 505 in response to the determination that the communication with the device 510 fails to satisfy the one or more criteria. In some examples, the parameter indication may indicate the second set of communication parameters, such as in accordance with the negotiated mapping of the bits. In some examples, the parameter indication may request for the device 510 to adjust the first set of communication parameters, such as to expand or contract the operation of the device 510 in accordance with operating constraints of the device 510.

At 530, the device 510 may transmit a response to the device 505 in response to the parameter indication. In some examples, the response may be a confirmation of a usage of the second set of wireless communication parameters by the device 510. That is, the confirmation may indicate that the device 510 complies with the parameter indication and switches to use the second set of communication parameters for communicating with the device 505. In some examples, the response may be a rejection of the second set of wireless communication parameters by the device 510. That is, the rejection may indicate that the device 510 rejects the parameter indication and refrains from switching to use the second set of communication parameters for communicating with the device 505.

In some examples, the response may indicate the second set of communication parameters determined by the device 510. For example, if the parameter indication is a request to adjust the first set of communication parameters, the device 510 may determine the second set of communication parameters. In some examples, the device 510 may transmit the response to indicate the determined second set of communication parameters, such as in accordance with the negotiated mapping of the bits.

At 535, the device 505 and the device 510 may negotiate another set of communication parameters for the device 510 to use to communicate with the device 505. For example, in response to the parameter indication or the response to the parameter indication (such as the response indicating the determined second set of communication parameters) the device 505 and the device 510 may communicate one or more frames that indicate, confirm, or reject, one or more other sets of communication parameters for the device 510 to use.

At 540, the device 505 and the device 510 may communicate one or more frames. For example, the device 505 and the device 510 may communicate the one or more frames in accordance with the second set of communication parameters or the negotiated set of communication parameters. Alternatively, if the device 510 rejects the parameter indication, the device 505 and the device 510 may communicate the one or more frames in accordance with the first set of communication parameters.

FIG. 6 illustrates an example of a process flow 600 showing operations performed by wireless devices to support link parameter recommendation in a wireless local area network. The process flow 600 may implement aspects of WLAN 100. For example, process flow 600 may be implemented by a device 605 and a device 610. The device 605 and the device 610 may be examples of the devices 305 or 505 and the devices 310 or 510, respectively, as described herein, including with reference to FIGS. 3 and 5.

In the following description of process flow 600, the operations between the device 605 and the device 610 may be performed in a different order than the order shown, or other operations may be added or removed from the process flow 600. Specific operations may also be left out of the process flow 600 or may be performed in different orders or at different times. Although the device 605 and the device 610 are shown performing the operations of the process flow 600, some aspects of some operation may also be performed by one or more other wireless communication devices. Further, although some operations or signaling may be shown to occur at different times for discussion purposes, these operations may actually occur at the same time.

At 615, the device 605 and the device 610 may communicate via one or more links. For example, the device 610 may use a first set of communication parameters to communicate with the device 605. In some examples, the device 610 may transmit one or more trigger-based frames in accordance with the first set of communication parameters as assigned by the device 605.

At 620, the device 605 and the device 610 may perform a parameter mapping negotiation to negotiate a mapping of bits to respective sets of communication parameters of sets of parameter adjustments, such as mappings to parameters 445 described with reference to FIG. 4. For example, the device 610 may support requesting for the device 605 to trigger the device 610 to transmit one or more frames in accordance with a requested set of communication parameters (such as a second set set of communication parameters). In some examples, the device 610 may indicate the requested set of communication parameters by indicating the requested set of communication parameters or by indicating a set of parameter adjustments (such as relative to the first set of communication parameters or a capability of the device 610) such that the requested set of communication parameters may be generated.

As described with reference to FIG. 4, to reduce signaling overhead, to request the set of communication parameters within the bit constraints of a frame 405, or both, bits of trigger request (such as a trigger request 350, a frame 405) may map to respective sets of communication parameters or parameter adjustments that may be requested by the device 610. To support such mapping, the device 605 and the device 610 may communicate one or more frames to negotiate a respective mapping of each bit. For example, the device 605 and the device 610 may communicate the frames to recommend respective mappings for each bit to which the other device may confirm or reject the mapping. Frames may continue to be communicated until a final mapping for each of the bits is agreed upon by the device 605 and the device 610.

At 625, the device 610 may transmit the trigger request to the device 605 that requests for the device 605 to trigger the device 610 to transmit the one or more frames. The trigger request may indicate the requested set of communication parameters with which the device 610 requests to be configured to transmit the one or more frames. In some examples, the trigger request may indicate the requested set of communication parameters in accordance with the negotiated mapping.

At 630, the device 605 may transmit a trigger frame in response to the trigger request that triggers the device 610 to transmit the one or more frames. In some examples, the trigger frame may indicate for the device 610 to transmit the one or more frames in accordance with (such as using) the requested set of communication parameters.

At 635, the device 610 may transmit the one or more frames to the device 605 in response to the trigger frame, such as in accordance with the requested set of communication parameters.

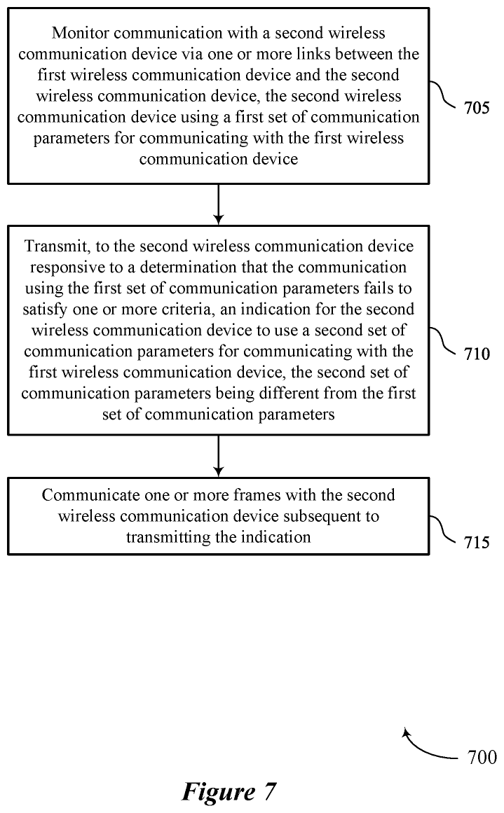

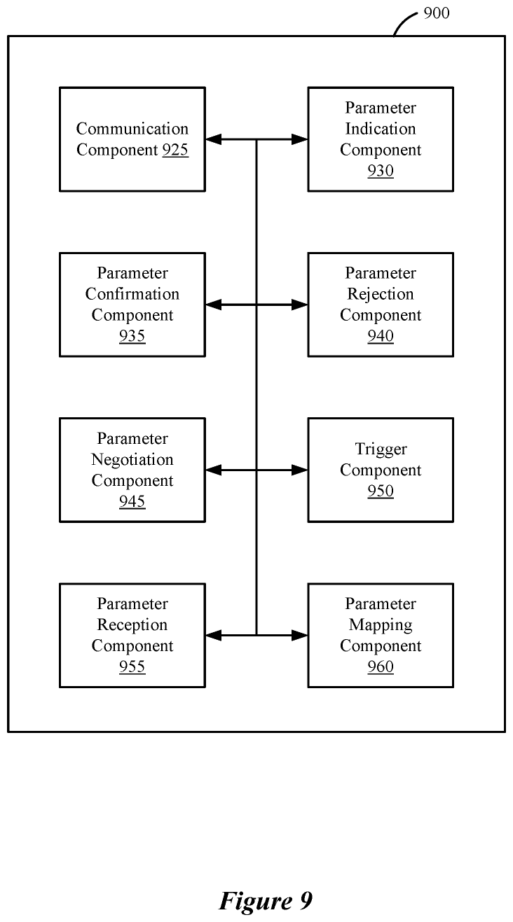

FIG. 7 shows a flowchart illustrating an example process 700 performable at a wireless communication device that supports link parameter recommendation in a WLAN according to some aspects of the present disclosure. The operations of the process 700 may be implemented by a wireless communication device, such as an AP, an MLD, an AP MLD, a non-AP, a non-AP MLD, or a non-AP STA, or its components as described herein. For example, the process 700 may be performed by a first wireless communication device, such as the wireless communication device 900 described with reference to FIG. 9. In some examples, the process 700 may be performed by a wireless AP such as one of the APs 102 described with reference to FIG. 1. In some examples, the process 700 may be performed by a wireless communication device, such as a device 305, a device 505, or a device 605 as described with reference to FIGS. 3 through 6.

In some examples, at 705, the process 700 may include monitoring communication with a second wireless communication device via one or more links between the first wireless communication device and the second wireless communication device, the second wireless communication device using a first set of communication parameters for communicating with the first wireless communication device. The operations of 705 may be performed in accordance with examples as disclosed herein. In some examples, aspects of the operations of 705 may be performed by a communication component 925 as described with reference to FIG. 9.

In some examples, at 710, the process 700 may include transmitting, to the second wireless communication device responsive to a determination (such as using one or more machine learning techniques) that the communication using the first set of communication parameters fails to satisfy one or more criteria, an indication for the second wireless communication device to use a second set of communication parameters for communicating with the first wireless communication device, the second set of communication parameters being different from the first set of communication parameters. The operations of 710 may be performed in accordance with examples as disclosed herein. In some examples, aspects of the operations of 710 may be performed by a parameter indication component 930 as described with reference to FIG. 9.

In some examples, at 715, the process 700 may include communicating one or more frames with the second wireless communication device subsequent to transmitting the indication. The operations of 715 may be performed in accordance with examples as disclosed herein. In some examples, aspects of the operations of 715 may be performed by a communication component 925 as described with reference to FIG. 9.

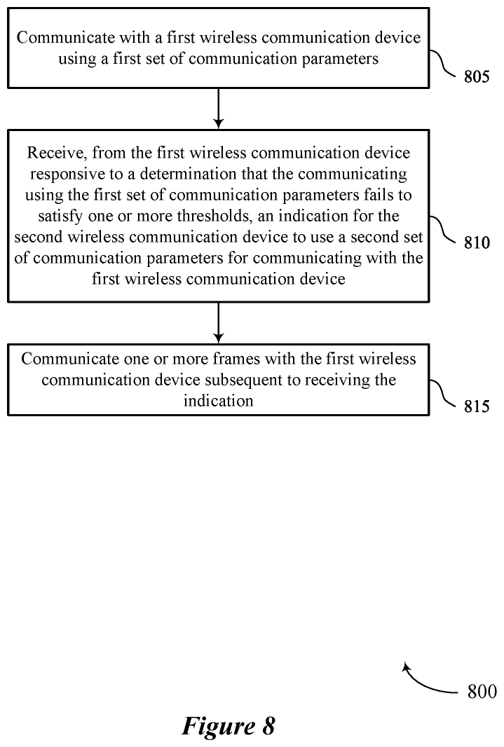

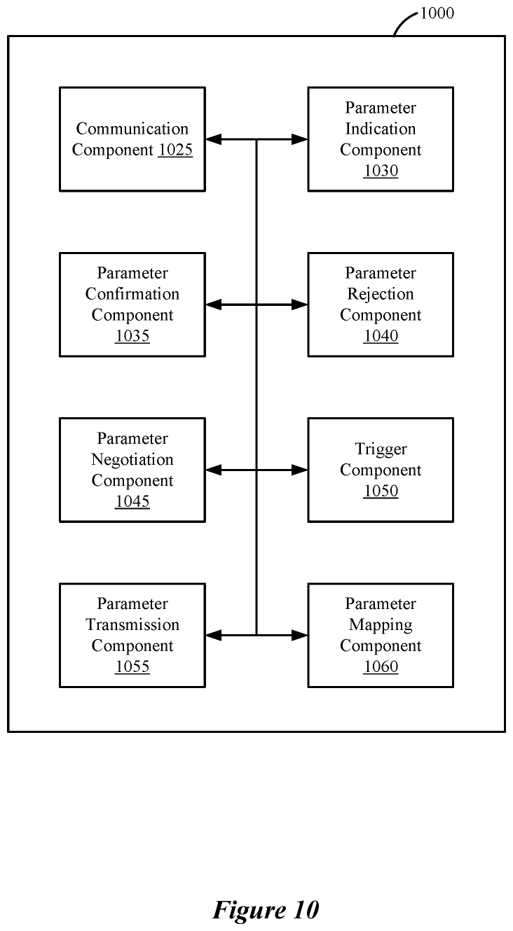

FIG. 8 shows a flowchart illustrating an example process 800 performable at a wireless communication device that supports link parameter recommendation in a WLAN according to some aspects of the present disclosure. The operations of the process 800 may be implemented by a wireless communication device, such as a STA, an MLD, a non-AP STA, or a non-AP MLD, or its components as described herein. For example, the process 800 may be performed by a second wireless communication device, such as the wireless communication device 1000 described with reference to FIG. 10. In some examples, the process 800 may be performed by a wireless STA such as one of the STAs 104 described with reference to FIG. 1. In some examples, the process 700 may be performed by a wireless communication device, such as a device 310, a device 510, or a device 610 as described with reference to FIGS. 3 through 6.

In some examples, at 805, the process 800 may include communicating with a first wireless communication device using a first set of communication parameters. The operations of 805 may be performed in accordance with examples as disclosed herein. In some examples, aspects of the operations of 805 may be performed by a communication component 1025 as described with reference to FIG. 10.

In some examples, at 810, the process 800 may include receiving, from the first wireless communication device responsive to a determination that the communicating using the first set of communication parameters fails to satisfy one or more criteria, an indication for the second wireless communication device to use a second set of communication parameters for communicating with the first wireless communication device. The operations of 810 may be performed in accordance with examples as disclosed herein. In some examples, aspects of the operations of 810 may be performed by a parameter indication component 1030 as described with reference to FIG. 10.

In some examples, at 815, the process 800 may include communicating one or more frames with the first wireless communication device subsequent to receiving the indication. The operations of 815 may be performed in accordance with examples as disclosed herein. In some examples, aspects of the operations of 815 may be performed by a communication component 1025 as described with reference to FIG. 10.

FIG. 9 shows a block diagram of an example wireless communication device 900 that supports link parameter recommendation in a WLAN according to some aspects of the present disclosure. In some examples, the wireless communication device 900 is configured or operable to perform the process 700 described with reference to FIG. 7. In various examples, the wireless communication device 900 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some examples, the wireless communication device 900 can be a device for use in an AP, such as AP 102 described with reference to FIG. 1. In some other examples, the wireless communication device 900 can be a device for use in a STA, such as STA 104 described with reference to FIG. 1. In some other examples, the wireless communication device 900 can be an AP (or a STA) that includes such a chip, SoC, chipset, package or device as well as multiple antennas. The wireless communication device 900 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 900 also includes or can be coupled with an application processor which may be further coupled with another memory. In some examples, the wireless communication device 900 further includes at least one external network interface that enables communication with a core network or backhaul network to gain access to external networks including the Internet.

The wireless communication device 900 includes a communication component 925, a parameter indication component 930, a parameter confirmation component 935, a parameter rejection component 940, a parameter negotiation component 945, a trigger component 950, a parameter reception component 955, a parameter mapping component 960, or any combination thereof. Portions of one or more of the components 925, 930, 935, 940, 945, 950, 955, and 960 may be implemented at least in part in hardware or firmware. For example, the parameter indication component 930 may be implemented at least in part by a modem. In some examples, at least some of the components 925, 930, 935, 940, 945, 950, 955, and 960 are implemented at least in part by a processor and as software stored in a memory. For example, portions of one or more of the components 925, 930, 935, 940, 945, 950, 955, or 960 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the device 900). For example, a processing system of the device 900 may refer to a system including the various other components or subcomponents of the device 900, such as the processor, or a transceiver, or a communications manager, or other components or combinations of components of the device 900. The processing system of the device 900 may interface with other components of the device 900, and may process information received from other components (such as inputs or signals) or output information to other components. For example, a chip or modem of the device 900 may include a processing system, a first interface to output information and a second interface to obtain information. In some implementations, the first interface may refer to an interface between the processing system of the chip or modem and a transmitter, such that the device 900 may transmit information output from the chip or modem. In some implementations, the second interface may refer to an interface between the processing system of the chip or modem and a receiver, such that the device 900 may obtain information or signal inputs, and the information may be passed to the processing system. A person having ordinary skill in the art will readily recognize that the first interface also may obtain information or signal inputs, and the second interface also may output information or signal outputs.

The communication component 925 may be configured as or otherwise support a means for monitoring communication with a second wireless communication device via one or more links between the first wireless communication device (such as the wireless communication device 900) and the second wireless communication device, the second wireless communication device using a first set of communication parameters for communicating with the first wireless communication device. The parameter indication component 930 may be configured as or otherwise support a means for transmitting, to the second wireless communication device responsive to a determination that the communication using the first set of communication parameters fails to satisfy one or more criteria, an indication for the second wireless communication device to use a second set of communication parameters for communicating with the first wireless communication device, the second set of communication parameters being different from the first set of communication parameters. The communication component 925 may be configured as or otherwise support a means for communicating one or more frames with the second wireless communication device subsequent to transmitting the indication.

In some examples, to support transmitting the indication, the parameter indication component 930 may be configured as or otherwise support a means for transmitting a frame that includes a recommendation that second wireless communication device use the second set of communication parameters for the second wireless communication device to use to communicate with the first wireless communication device.

In some examples, to support transmitting the indication, the parameter indication component 930 may be configured as or otherwise support a means for transmitting a request for the second wireless communication device to adjust the first set of communication parameters, the second set of communication parameters being the adjusted first set of communication parameters.

In some examples, the parameter reception component 955 may be configured as or otherwise support a means for receiving, from the second wireless communication device in response to the request, a second indication of the second set of communication parameters, the one or more frames communicated in accordance with the second set of communication parameters in accordance with receiving the second indication.

In some examples, to support communicating the one or more frames, the communication component 925 may be configured as or otherwise support a means for communicating, in response to the request, the one or more frames in accordance with the second set of communication parameters.

In some examples, to support transmitting the indication, the parameter indication component 930 may be configured as or otherwise support a means for transmitting a request for the second wireless communication device to activate or deactivate one or more links for communicating with the first wireless communication device using the second set of communication parameters, the request including the second set of communication parameters.

In some examples, the parameter confirmation component 935 may be configured as or otherwise support a means for receiving, from the second wireless communication device in response to the indication, a second indication of a confirmation of a usage, by the second wireless communication device, of the second set of communication parameters for communicating with the first wireless communication device, the one or more frames communicated in accordance with the second set of communication parameters in accordance with the confirmation.

In some examples, the parameter rejection component 940 may be configured as or otherwise support a means for receiving, from the second wireless communication device in response to the indication, a second indication of a rejection, by the second wireless communication device, to use the second set of communication parameters for communicating with the first wireless communication device, the one or more frames communicated in accordance with the first set of communication parameters.

In some examples, the communication component 925 may be configured as or otherwise support a means for determining an adherence to the indication by the second wireless communication device in accordance with communicating the one or more frames in accordance with the second set of communication parameters.

In some examples, the parameter negotiation component 945 may be configured as or otherwise support a means for receiving, from the second wireless communication device in response to the indication, a second indication of a third set of communication parameters for the second wireless communication device to use for communicating with the first wireless communication device. In some examples, the parameter negotiation component 945 may be configured as or otherwise support a means for transmitting, in response to the second indication, a third indication of a confirmation of the third set of communication parameters for the second wireless communication device to use for communicating with the first wireless communication device or of a fourth set of communication parameters for the second wireless communication device to use for communicating with the first wireless communication device, the one or more frames communicated in accordance with the third set of communication parameters, the fourth set of communication parameters, or a fifth set of communication parameters in accordance with the third indication.

In some examples, the indication includes a second indication of which one or more links of a set of links between the first wireless communication device and the second wireless communication device for which the second wireless communication device is to use the second set of communication parameters for communicating with the first wireless communication device.

In some examples, the second indication includes a set of bits, each bit of the set of bits associated with a respective link of the set of links and indicating whether the second wireless communication device is to use the second set of communication parameters for communicating with the first wireless communication device via the respective link.

In some examples, the second set of communication parameters includes at least one of a bandwidth for the second wireless communication device to use, a number N_{SS} of spatial streams for the second wireless communication device to use, a MCS for the second wireless communication device to use, a first mode of operation to enable for communicating with the first wireless communication device, a second mode of operation to disable for communicating with the first wireless communication device, a TID-to-link mapping for the second wireless communication device to use, a type of PPDU for the second wireless communication device to use, or any combination thereof.

In some examples, the first mode of operation includes an EMLSR mode, an EMLMR mode, an MLMR mode, an MLSR mode, a multi-primary channel mode, spatial multiplexing power save mode, or a packet repetition mode that indicates at least one of a repetition of the one or more frames on a link between the first wireless communication device and the second wireless communication device or a duplication of the one or more frames across a set links between the first wireless communication device and the second wireless communication device. In some examples, the second mode of operation includes the EMLSR mode, the EMLMR mode, the MLMR mode, the MLSR mode, the multi-primary channel mode, spatial multiplexing power save mode, or the packet repetition mode.

In some examples, to support transmitting the indication, the parameter indication component 930 may be configured as or otherwise support a means for transmitting a frame including a set of bits, each bit of the set of bits mapping to a respective set of communication parameters for the second wireless communication device to use for communicating with the first wireless communication device or to a respective set of adjustments to the first set of communication parameters, the indication being for the second wireless communication device to use the second set of communication parameters in accordance with a value of a first bit of the set of bits that maps to the second set of communication parameters or to a first set of adjustments to the first set of communication parameters used to generate the second set of communication parameters.

In some examples, the parameter mapping component 960 may be configured as or otherwise support a means for communicating one or more second frames with the second wireless communication device to negotiate a respective mapping of each bit to the respective set of communication parameters or to the respective set of adjustments.

In some examples, the communication component 925 may be configured as or otherwise support a means for establishing a link with the second wireless communication device in accordance with a capability of the first wireless communication device to negotiate the respective mapping and a capability of the second wireless communication device to negotiate the respective mapping.

In some examples, to support transmitting the indication, the parameter indication component 930 may be configured as or otherwise support a means for transmitting the indication via A-Control signaling, a block ACK frame, or an action frame.

In some examples, the trigger component 950 may be configured as or otherwise support a means for receiving, from the second wireless communication device, a request to trigger the second wireless communication device to transmit one or more second frames to the first wireless communication device, the request including a third set of communication parameters associated with transmitting the one or more second frames to the first wireless communication device. In some examples, the trigger component 950 may be configured as or otherwise support a means for transmitting, to the second wireless communication device and in accordance with the request, a trigger frame that triggers the second wireless communication device to transmit the one or more second frames to the first wireless communication device.

In some examples, the communication component 925 may be configured as or otherwise support a means for receiving, from the second wireless communication device, the one or more second frames in accordance with the trigger frame triggering the second wireless communication device to transmit the one or more second frames in accordance with the third set of communication parameters.

In some examples, to support transmitting the indication, the parameter indication component 930 may be configured as or otherwise support a means for transmitting the indication via a second link different than the first link.

In some examples, the first wireless communication device is a first access AP MLD, a first AP STA, a first non-AP MLD, a first non-AP STA, or a combination thereof. In some examples, the second wireless communication device is a second AP MLD, a second non-AP MLD, a second AP STA, a second non-AP STA, or a combination thereof.

FIG. 10 shows a block diagram of an example wireless communication device 1000 that supports link parameter recommendation in a WLAN according to some aspects of the present disclosure. In some examples, the wireless communication device 1000 is configured or operable to perform the process 800 described with reference to FIG. 8. In various examples, the wireless communication device 1000 can be a chip, SoC, chipset, package or device that may include: one or more modems (such as, a Wi-Fi (IEEE 802.11) modem or a cellular modem such as 3GPP 4G LTE or 5G compliant modem), one or more processors, processing blocks or processing elements (collectively “the processor”); one or more radios (collectively “the radio”); and one or more memories or memory blocks (collectively “the memory”).

In some examples, the wireless communication device 1000 can be a device for use in a STA, such as STA 104 described with reference to FIG. 1. In some other examples, the wireless communication device 1000 can be a device for use in an AP, such as AP 102 described with reference to FIG. 1. In some other examples, the wireless communication device 1000 can be a STA (or an AP) that includes such a chip, SoC, chipset, package or device as well as multiple antennas. The wireless communication device 1000 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1000 also includes or can be coupled with an application processor which may be further coupled with another memory. In some examples, the wireless communication device 1000 further includes a user interface (UI) (such as a touchscreen or keypad) and a display, which may be integrated with the UI to form a touchscreen display. In some examples, the wireless communication device 1000 may further include one or more sensors such as, for example, one or more inertial sensors, accelerometers, temperature sensors, pressure sensors, or altitude sensors.

The wireless communication device 1000 includes a communication component 1025, a parameter indication component 1030, a parameter confirmation component 1035, a parameter rejection component 1040, a parameter negotiation component 1045, a trigger component 1050, a parameter transmission component 1055, a parameter mapping component 1060, or any combination thereof. Portions of one or more of the components 1025, 1030, 1035, 1040, 1045, 1050, 1055, and 1060 may be implemented at least in part in hardware or firmware. For example, the parameter indication component 1030 may be implemented at least in part by a modem. In some examples, at least some of the components 1025, 1030, 1035, 1040, 1045, 1050, 1055, and 1060 are implemented at least in part by a processor and as software stored in a memory. For example, portions of one or more of the components 1025, 1030, 1035, 1040, 1045, 1050, 1055, or 1060 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the device 1000). For example, a processing system of the device 1000 may refer to a system including the various other components or subcomponents of the device 1000, such as the processor, or a transceiver, or a communications manager, or other components or combinations of components of the device 1000. The processing system of the device 1000 may interface with other components of the device 1000, and may process information received from other components (such as inputs or signals) or output information to other components. For example, a chip or modem of the device 1000 may include a processing system, a first interface to output information and a second interface to obtain information. In some implementations, the first interface may refer to an interface between the processing system of the chip or modem and a transmitter, such that the device 1000 may transmit information output from the chip or modem. In some implementations, the second interface may refer to an interface between the processing system of the chip or modem and a receiver, such that the device 1000 may obtain information or signal inputs, and the information may be passed to the processing system. A person having ordinary skill in the art will readily recognize that the first interface also may obtain information or signal inputs, and the second interface also may output information or signal outputs.

The communication component 1025 may be configured as or otherwise support a means for communicating with a first wireless communication device using a first set of communication parameters. The parameter indication component 1030 may be configured as or otherwise support a means for receiving, from the first wireless communication device responsive to a determination that the communicating using the first set of communication parameters fails to satisfy one or more criteria, an indication for the second wireless communication device (such as the wireless communication device 1000) to use a second set of communication parameters for communicating with the first wireless communication device. The communication component 1025 may be configured as or otherwise support a means for communicating one or more frames with the first wireless communication device subsequent to receiving the indication.

In some examples, to support receiving the indication, the parameter indication component 1030 may be configured as or otherwise support a means for receiving a frame that includes a recommendation that the second wireless communication device use the second set of communication parameters to communicate with the first wireless communication device.

In some examples, to support receiving the indication, the parameter indication component 1030 may be configured as or otherwise support a means for receiving a request for the second wireless communication device to adjust the first set of communication parameters, the second set of communication parameters being the adjusted first set of communication parameters.

In some examples, the parameter transmission component 1055 may be configured as or otherwise support a means for transmitting, to the first wireless communication device in response to the request, a second indication of the second set of communication parameters, the one or more frames communicated in accordance with the second set of communication parameters in accordance with receiving the second indication.

In some examples, to support communicating the one or more frames, the communication component 1025 may be configured as or otherwise support a means for communicating, in response to the request, the one or more frames in accordance with the second set of communication parameters.

In some examples, to support receiving the indication, the parameter indication component 1030 may be configured as or otherwise support a means for receiving a request for the second wireless communication device to activate or deactivate one or more links for communicating with the first wireless communication device using the second set of communication parameters, the request including the second set of communication parameters.

In some examples, the parameter confirmation component 1035 may be configured as or otherwise support a means for transmitting, to the first wireless communication device in response to the indication, a second indication of a confirmation of a usage, by the second wireless communication device, of the second set of communication parameters for communicating with the first wireless communication device, the one or more frames communicated in accordance with the second set of communication parameters in accordance with the confirmation.

In some examples, the parameter rejection component 1040 may be configured as or otherwise support a means for transmitting, to the first wireless communication device in response to the indication, a third indication of a rejection, by the second wireless communication device, to use the second set of communication parameters for communicating with the first wireless communication device, the one or more frames communicated in accordance with the first set of communication parameters.

In some examples, the parameter rejection component 1040 may be configured as or otherwise support a means for ignoring the indication from the first wireless communication device in accordance with one or more operating parameters of the second wireless communication device, the one or more frames communicated in accordance with the first set of communication parameters in accordance with the ignoring.

In some examples, the parameter negotiation component 1045 may be configured as or otherwise support a means for transmitting, to the first wireless communication device in response to the indication, a second indication of a third set of communication parameters for the second wireless communication device to use for communicating with the first wireless communication device. In some examples, the parameter negotiation component 1045 may be configured as or otherwise support a means for receiving, in response to the second indication, a third indication of a confirmation of the third set of communication parameters for the second wireless communication device to use for communicating with the first wireless communication device or of a fourth set of communication parameters for the second wireless communication device to use for communicating with the first wireless communication device, the one or more frames communicated in accordance with the third set of communication parameters, the fourth set of communication parameters, or a fifth set of communication parameters in accordance with the third indication.

In some examples, the indication includes a second indication of which one or more links of a set of links between the first wireless communication device and the second wireless communication device for which the second wireless communication device is to use the second set of communication parameters for communicating with the first wireless communication device.

In some examples, the second indication includes a set of bits, each bit of the set of bits associated with a respective link of the set of links and indicating whether the second wireless communication device is to use the second set of communication parameters for communicating with the first wireless communication device via the respective link.

In some examples, the second set of communication parameters includes at least one of a bandwidth for the second wireless communication device to use, a number of spatial streams for the second wireless communication device to use, a modulation and coding scheme for the second wireless communication device to use, a first mode of operation to enable for communicating with the first wireless communication device, a second mode of operation to disable for communicating with the first wireless communication device, a traffic identifier-to-link mapping for the second wireless communication device to use, a type of physical layer protocol data unit for the second wireless communication device to use, or any combination thereof.

In some examples, the first mode of operation includes an EMLSR mode, an EMLMR mode, an MLMR mode, an MLSR mode, a multi-primary channel mode, spatial multiplexing power save mode, or a packet repetition mode that indicates at least one of a repetition of the one or more frames on a link between the first wireless communication device and the second wireless communication device or a duplication of the one or more frames across a set links between the first wireless communication device and the second wireless communication device. In some examples, the second mode of operation includes the EMLSR mode, the EMLMR mode, the MLMR mode, the MLSR mode, the multi-primary channel mode, spatial multiplexing power save mode, or the packet repetition mode.

In some examples, to support receiving the indication, the parameter indication component 1030 may be configured as or otherwise support a means for receiving a frame including a set of bits, each bit of the set of bits mapping to a respective set of communication parameters for the second wireless communication device to use for communicating with the first wireless communication device or to a respective set of adjustments to the first set of communication parameters, the indication being for the second wireless communication device to use the second set of communication parameters in accordance with a value of a first bit of the set of bits that maps to the second set of communication parameters or to a first set of adjustments to the first set of communication parameters used to generate the second set of communication parameters.

In some examples, the parameter mapping component 1060 may be configured as or otherwise support a means for communicating one or more second frames with the second wireless communication device to negotiate a respective mapping of each bit to the respective set of communication parameters or to the respective set of adjustments.

In some examples, the communication component 1025 may be configured as or otherwise support a means for establishing a link with the first wireless communication device in accordance with a capability of the first wireless communication device to negotiate the respective mapping and a capability of the second wireless communication device to negotiate the respective mapping.

In some examples, to support receiving the indication, the parameter indication component 1030 may be configured as or otherwise support a means for receiving the indication via A-Control signaling, a block ACK frame, or an action frame.

In some examples, the trigger component 1050 may be configured as or otherwise support a means for transmitting, to the first wireless communication device, a request to trigger the second wireless communication device to transmit one or more second frames to the first wireless communication device, the request including a third set of communication parameters associated with transmitting the one or more second frames to the first wireless communication device. In some examples, the trigger component 1050 may be configured as or otherwise support a means for receiving, from the first wireless communication device and in accordance with the request, a trigger frame that triggers the second wireless communication device to transmit the one or more second frames to the first wireless communication device.

In some examples, the communication component 1025 may be configured as or otherwise support a means for transmitting, to the first wireless communication device, the one or more second frames in accordance with the trigger frame triggering the second wireless communication device to transmit the one or more second frames in accordance with the third set of communication parameters.

In some examples, to support receiving the indication, the parameter indication component 1030 may be configured as or otherwise support a means for receiving the indication via a second link different than the first link.

In some examples, the first wireless communication device is a first access AP MLD, a first AP STA, a first non-AP MLD, a first non-AP STA, or a combination thereof. In some examples, the second wireless communication device is a second AP MLD, a second non-AP MLD, a second AP STA, a second non-AP STA, or a combination thereof.

Implementation examples are described in the following numbered clauses:
Aspect 1: A method for wireless communications at a first wireless communication device, comprising: monitoring communication with a second wireless communication device via one or more links between the first wireless communication device and the second wireless communication device, the second wireless communication device using a first set of communication parameters for communicating with the first wireless communication device; transmitting, to the second wireless communication device responsive to a determination that the communication using the first set of communication parameters fails to satisfy one or more criteria, an indication for the second wireless communication device to use a second set of communication parameters for communicating with the first wireless communication device, the second set of communication parameters being different from the first set of communication parameters; and communicating one or more frames with the second wireless communication device subsequent to transmitting the indication.
Aspect 2: The method of aspect 1, wherein transmitting the indication comprises: transmitting a frame that comprises a recommendation that the second wireless communication device use the second set of communication parameters to communicate with the first wireless communication device.
Aspect 3: The method of aspect 1, wherein transmitting the indication comprises: transmitting a request for the second wireless communication device to adjust the first set of communication parameters, the second set of communication parameters being the adjusted first set of communication parameters.
Aspect 4: The method of aspect 3, further comprising: receiving, from the second wireless communication device in response to the request, a second indication of the second set of communication parameters, the one or more frames communicated in accordance with the second set of communication parameters in accordance with receiving the second indication.
Aspect 5: The method of any of aspects 3 through 4, wherein communicating the one or more frames comprises: communicating, in response to the request, the one or more frames in accordance with the second set of communication parameters.
Aspect 6: The method of any of aspects 1 through 5, wherein transmitting the indication comprises: transmitting a request for the second wireless communication device to activate or deactivate one or more links for communicating with the first wireless communication device using the second set of communication parameters, the request comprising the second set of communication parameters.
Aspect 7: The method of any of aspects 1 through 6, further comprising: receiving, from the second wireless communication device in response to the indication, a second indication of a confirmation of a usage, by the second wireless communication device, of the second set of communication parameters for communicating with the first wireless communication device, the one or more frames communicated in accordance with the second set of communication parameters in accordance with the confirmation.
Aspect 8: The method of any of aspects 1 through 3 and 6, further comprising: receiving, from the second wireless communication device in response to the indication, a second indication of a rejection, by the second wireless communication device, to use the second set of communication parameters for communicating with the first wireless communication device, the one or more frames communicated in accordance with the first set of communication parameters.
Aspect 9: The method of any of aspects 1 through 7, further comprising: determining an adherence to the indication by the second wireless communication device in accordance with communicating the one or more frames in accordance with the second set of communication parameters.
Aspect 10: The method of any of aspects 1 through 3, further comprising: receiving, from the second wireless communication device in response to the indication, a second indication of a third set of communication parameters for the second wireless communication device to use for communicating with the first wireless communication device; and transmitting, in response to the second indication, a third indication of a confirmation of the third set of communication parameters for the second wireless communication device to use for communicating with the first wireless communication device or of a fourth set of communication parameters for the second wireless communication device to use for communicating with the first wireless communication device, the one or more frames communicated in accordance with the third set of communication parameters, the fourth set of communication parameters, or a fifth set of communication parameters in accordance with the third indication.
Aspect 11: The method of any of aspects 1 through 10, wherein the indication comprises a second indication of which one or more links of a set of links between the first wireless communication device and the second wireless communication device for which the second wireless communication device is to use the second set of communication parameters for communicating with the first wireless communication device.
Aspect 12: The method of aspect 11, wherein the second indication comprises a set of bits, each bit of the set of bits associated with a respective link of the set of links and indicating whether the second wireless communication device is to use the second set of communication parameters for communicating with the first wireless communication device via the respective link.
Aspect 13: The method of any of aspects 1 through 12, wherein the second set of communication parameters comprises at least one of a bandwidth for the second wireless communication device to use, a number N_{SS} of spatial streams for the second wireless communication device to use, a MCS for the second wireless communication device to use, a first mode of operation to enable for communicating with the first wireless communication device, a second mode of operation to disable for communicating with the first wireless communication device, a TID-to-link mapping for the second wireless communication device to use, a type of PPDU for the second wireless communication device to use, or any combination thereof.
Aspect 14: The method of aspect 13, wherein the first mode of operation comprises an EMLSR mode, an EMLMR mode, an MLMR mode, an MLSR mode, a multi-primary channel mode, spatial multiplexing power save mode, or a packet repetition mode that indicates at least one of a repetition of the one or more frames on a link between the first wireless communication device and the second wireless communication device or a duplication of the one or more frames across a set links between the first wireless communication device and the second wireless communication device, and the second mode of operation comprises the EMLSR mode, the EMLMR mode, the MLMR mode, the MLSR mode, the multi-primary channel mode, spatial multiplexing power save mode, or the packet repetition mode.
Aspect 15: The method of any of aspects 1 through 2 and 6 through 14, wherein transmitting the indication comprises: transmitting a frame comprising a set of bits, each bit of the set of bits mapping to a respective set of communication parameters for the second wireless communication device to use for communicating with the first wireless communication device or to a respective set of adjustments to the first set of communication parameters, the indication being for the second wireless communication device to use the second set of communication parameters in accordance with a value of a first bit of the set of bits that maps to the second set of communication parameters or to a first set of adjustments to the first set of communication parameters used to generate the second set of communication parameters.
Aspect 16: The method of aspect 15, further comprising: communicating one or more second frames with the second wireless communication device to negotiate a respective mapping of each bit to the respective set of communication parameters or to the respective set of adjustments
Aspect 17: The method of aspect 16, further comprising: establishing a link with the second wireless communication device in accordance with a capability of the first wireless communication device to negotiate the respective mapping and a capability of the second wireless communication device to negotiate the respective mapping.
Aspect 18: The method of any of aspects 1 through 17, wherein transmitting the indication comprises: transmitting the indication via A-Control signaling, a block ACK frame, or an action frame.
Aspect 19: The method of any of aspects 1 through 18, further comprising: receiving, from the second wireless communication device, a request to trigger the second wireless communication device to transmit one or more second frames to the first wireless communication device, the request comprising a third set of communication parameters associated with transmitting the one or more second frames to the first wireless communication device; and transmitting, to the second wireless communication device and in accordance with the request, a trigger frame that triggers the second wireless communication device to transmit the one or more second frames to the first wireless communication device.
Aspect 20: The method of aspect 19, further comprising: receiving, from the second wireless communication device, the one or more second frames in accordance with the trigger frame triggering the second wireless communication device to transmit the one or more second frames in accordance with the third set of communication parameters.
Aspect 21: The method of any of aspects 1 through 20, wherein the second set of communication parameters is associated with communicating with the first wireless communication device via a first link between the first wireless communication device and the second wireless communication device, and wherein transmitting the indication comprises: transmitting the indication via a second link different than the first link.
Aspect 22: The method of any of aspects 1 through 21, wherein the first wireless communication device is a first AP MLD, a first AP STA, a first non-AP MLD, a first non-AP STA, or a combination thereof, and the second wireless communication device is a second AP MLD, a second non-AP MLD, a second AP STA, a second non-AP STA, or a combination thereof.
Aspect 23: A method for wireless communications at a second wireless communication device, comprising: communicating with a first wireless communication device using a first set of communication parameters; receiving, from the first wireless communication device responsive to a determination that the communicating using the first set of communication parameters fails to satisfy one or more criteria, an indication for the second wireless communication device to use a second set of communication parameters for communicating with the first wireless communication device; and communicating one or more frames with the first wireless communication device subsequent to receiving the indication.
Aspect 24: The method of aspect 23, wherein receiving the indication comprises: receiving a frame that comprises a recommendation that the second wireless communication device use the second set of communication parameters to communicate with the first wireless communication device.
Aspect 25: The method of aspect 23, wherein receiving the indication comprises: receiving a request for the second wireless communication device to adjust the first set of communication parameters, the second set of communication parameters being the adjusted first set of communication parameters.
Aspect 26: The method of aspect 25, further comprising: transmitting, to the first wireless communication device in response to the request, a second indication of the second set of communication parameters, the one or more frames communicated in accordance with the second set of communication parameters in accordance with receiving the second indication.
Aspect 27: The method of any of aspects 25 through 26, wherein communicating the one or more frames comprises: communicating, in response to the request, the one or more frames in accordance with the second set of communication parameters.
Aspect 28: The method of any of aspects 23 through 27, wherein receiving the indication comprises: receiving a request for the second wireless communication device to activate or deactivate one or more links for communicating with the first wireless communication device using the second set of communication parameters, the request comprising the second set of communication parameters.
Aspect 29: The method of any of aspects 23 through 28, further comprising: transmitting, to the first wireless communication device in response to the indication, a second indication of a confirmation of a usage, by the second wireless communication device, of the second set of communication parameters for communicating with the first wireless communication device, the one or more frames communicated in accordance with the second set of communication parameters in accordance with the confirmation.
Aspect 30: The method of any of aspects 23 through 28, further comprising: transmitting, to the first wireless communication device in response to the indication, a second indication of a rejection, by the second wireless communication device, to use the second set of communication parameters for communicating with the first wireless communication device, the one or more frames communicated in accordance with the first set of communication parameters.
Aspect 31: The method of any of aspects 23 through 28, further comprising: ignoring the indication from the first wireless communication device based at least in part on one or more operating parameters of the second wireless communication device, the one or more frames communicated in accordance with the first set of communication parameters based at least in part on the ignoring.
Aspect 32: The method of any of aspects 23 through 25 and 28, further comprising: transmitting, to the first wireless communication device in response to the indication, a second indication of a third set of communication parameters for the second wireless communication device to use for communicating with the first wireless communication device; and receiving, in response to the second indication, a third indication of a confirmation of the third set of communication parameters for the second wireless communication device to use for communicating with the first wireless communication device or of a fourth set of communication parameters for the second wireless communication device to use for communicating with the first wireless communication device, the one or more frames communicated in accordance with the third set of communication parameters, the fourth set of communication parameters, or a fifth set of communication parameters in accordance with the third indication.
Aspect 33: The method of any of aspects 23 through 32, wherein the indication comprises a second indication of which one or more links of a set of links between the first wireless communication device and the second wireless communication device for which the second wireless communication device is to use the second set of communication parameters for communicating with the first wireless communication device.
Aspect 34: The method of aspect 33, wherein the second indication comprises a set of bits, each bit of the set of bits associated with a respective link of the set of links and indicating whether the second wireless communication device is to use the second set of communication parameters for communicating with the first wireless communication device via the respective link.
Aspect 35: The method of any of aspects 23 through 34, wherein the second set of communication parameters comprises at least one of a bandwidth for the second wireless communication device to use, a number N_{SS} of spatial streams for the second wireless communication device to use, a MCS for the second wireless communication device to use, a first mode of operation to enable for communicating with the first wireless communication device, a second mode of operation to disable for communicating with the first wireless communication device, a TID-to-link mapping for the second wireless communication device to use, a type of PPDU for the second wireless communication device to use, or any combination thereof.
Aspect 36: The method of aspect 35, wherein the first mode of operation comprises an EMLSR mode, an EMLMR mode, an MLMR mode, an MLSR mode, a multi-primary channel mode, spatial multiplexing power save mode, or a packet repetition mode that indicates at least one of a repetition of the one or more frames on a link between the first wireless communication device and the second wireless communication device or a duplication of the one or more frames across a set links between the first wireless communication device and the second wireless communication device, and the second mode of operation comprises the EMLSR mode, the EMLMR mode, the MLMR mode, the MLSR mode, the multi-primary channel mode, spatial multiplexing power save mode, or the packet repetition mode.
Aspect 37: The method of any of aspects 23 through 24 and 28 through 36, wherein receiving the indication comprises: receiving a frame comprising a set of bits, each bit of the set of bits mapping to a respective set of communication parameters for the second wireless communication device to use for communicating with the first wireless communication device or to a respective set of adjustments to the first set of communication parameters, the indication being for the second wireless communication device to use the second set of communication parameters in accordance with a value of a first bit of the set of bits that maps to the second set of communication parameters or to a first set of adjustments to the first set of communication parameters used to generate the second set of communication parameters.
Aspect 38: The method of aspect 37, further comprising: communicating one or more second frames with the first wireless communication device to negotiate a respective mapping of each bit to the respective set of communication parameters or to the respective set of adjustments.
Aspect 39: The method of aspect 38, further comprising: establishing a link with the first wireless communication device based at least in part on a capability of the first wireless communication device to negotiate the respective mapping and a capability of the second wireless communication device to negotiate the respective mapping.
Aspect 40: The method of any of aspects 23 through 39, wherein receiving the indication comprises: receiving the indication via A-Control signaling, a block ACK frame, or an action frame.
Aspect 41: The method of any of aspects 23 through 40, further comprising: transmitting, to the first wireless communication device, a request to trigger the second wireless communication device to transmit one or more second frames to the first wireless communication device, the request comprising a third set of communication parameters associated with transmitting the one or more second frames to the first wireless communication device; and receiving, from the first wireless communication device and based at least in part on the request, a trigger frame that triggers the second wireless communication device to transmit the one or more second frames to the first wireless communication device.
Aspect 42: The method of aspect 41, further comprising: transmitting, to the first wireless communication device, the one or more second frames in accordance with the trigger frame triggering the second wireless communication device to transmit the one or more second frames in accordance with the third set of communication parameters.
Aspect 43: The method of any of aspects 23 through 42, wherein the second set of communication parameters is associated with communicating with the first wireless communication device via a first link between the first wireless communication device and the second wireless communication device, and wherein receiving the indication comprises: receiving the indication via a second link different than the first link.
Aspect 44: The method of any of aspects 23 through 43, wherein the first wireless communication device is a first AP MLD, a first AP STA, a first non-AP MLD, a first non-AP STA, or a combination thereof, and the second wireless communication device is a second AP MLD, a second non-AP MLD, a second AP STA, a second non-AP STA, or a combination thereof.
Aspect 45: An apparatus for wireless communications at a first wireless communication device, comprising a processor; memory coupled with the processor, the processor and memory operable to cause the apparatus to perform a method of any of aspects 1 through 22.
Aspect 46: An apparatus for wireless communications at a first wireless communication device, comprising at least one means for performing a method of any of aspects 1 through 22.
Aspect 47: A non-transitory computer-readable medium storing code for wireless communications at a first wireless communication device, the code comprising instructions executable by a processor to perform a method of any of aspects 1 through 22.
Aspect 48: An apparatus for wireless communications at a second wireless communication device, comprising a processor; memory coupled with the processor, the processor and memory operable to cause the apparatus to perform a method of any of aspects 23 through 44.
Aspect 49: An apparatus for wireless communications at a second wireless communication device, comprising at least one means for performing a method of any of aspects 23 through 44
Aspect 50: A non-transitory computer-readable medium storing code for wireless communications at a second wireless communication device, the code comprising instructions executable by a processor to perform a method of any of aspects 23 through 44.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrases “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communications at a first wireless communication device, comprising:
a processor; and
memory coupled with the processor, the processor and memory operable to cause the apparatus to:
monitor communication with a second wireless communication device via one or more links between the first wireless communication device and the second wireless communication device, the second wireless communication device using a first set of communication parameters for communicating with the first wireless communication device;
transmit, to the second wireless communication device responsive to a determination that the communication using the first set of communication parameters fails to satisfy one or more criteria, an indication for the second wireless communication device to use a second set of communication parameters for communicating with the first wireless communication device, the second set of communication parameters being different from the first set of communication parameters; and
communicate one or more frames with the second wireless communication device subsequent to transmitting the indication.

2. The apparatus of claim 1, wherein, to transmit the indication, the processor and memory are operable to cause the apparatus to:
transmit a frame that comprises a recommendation that the second wireless communication device use the second set of communication parameters to communicate with the first wireless communication device.

3. The apparatus of claim 1, wherein, to transmit the indication, the processor and memory are operable to cause the apparatus to:
transmit a request for the second wireless communication device to adjust the first set of communication parameters, the second set of communication parameters being the adjusted first set of communication parameters.

4. The apparatus of claim 3, wherein the processor and memory are further operable to cause the apparatus to:
receive, from the second wireless communication device in response to the request, a second indication of the second set of communication parameters, the one or more frames communicated in accordance with the second set of communication parameters in accordance with receiving the second indication.

5. The apparatus of claim 3, wherein, to communicate the one or more frames, the processor and memory are operable to cause the apparatus to:
communicating, in response to the request, the one or more frames in accordance with the second set of communication parameters.

6. The apparatus of claim 1, wherein, to transmit the indication, the processor and memory are operable to cause the apparatus to:
transmit a request for the second wireless communication device to activate one or more links for communicating with the first wireless communication device using the second set of communication parameters, the request comprising the second set of communication parameters.

7. The apparatus of claim 1, wherein the processor and memory are further operable to cause the apparatus to:
receive, from the second wireless communication device in response to the indication, a second indication of a confirmation of a usage, by the second wireless communication device, of the second set of communication parameters for communicating with the first wireless communication device,
the one or more frames communicated in accordance with the second set of communication parameters in accordance with the confirmation.

8. The apparatus of claim 1, wherein the processor and memory are further operable to cause the apparatus to:
receive, from the second wireless communication device in response to the indication, a second indication of a rejection, by the second wireless communication device, to use the second set of communication parameters for communicating with the first wireless communication device,
the one or more frames communicated in accordance with the first set of communication parameters.

9. The apparatus of claim 1, wherein the processor and memory are further operable to cause the apparatus to:
determine an adherence to the indication by the second wireless communication device in accordance with communicating the one or more frames in accordance with the second set of communication parameters.

10. The apparatus of claim 1, wherein the processor and memory are further operable to cause the apparatus to:
receive, from the second wireless communication device in response to the indication, a second indication of a third set of communication parameters for the second wireless communication device to use for communicating with the first wireless communication device; and
transmit, in response to the second indication, a third indication of a confirmation of the third set of communication parameters for the second wireless communication device to use for communicating with the first wireless communication device or of a fourth set of communication parameters for the second wireless communication device to use for communicating with the first wireless communication device,
the one or more frames communicated in accordance with the third set of communication parameters, the fourth set of communication parameters, or a fifth set of communication parameters in accordance with the third indication.

11. The apparatus of claim 1, wherein the indication comprises a second indication of which one or more links of a set of links between the first wireless communication device and the second wireless communication device for which the second wireless communication device is to use the second set of communication parameters for communicating with the first wireless communication device.

12. The apparatus of claim 11, wherein the second indication comprises a set of bits, each bit of the set of bits associated with a respective link of the set of links and indicating whether the second wireless communication device is to use the second set of communication parameters for communicating with the first wireless communication device via the respective link.

13. The apparatus of claim 1, wherein:
the second set of communication parameters comprises at least one of a bandwidth for the second wireless communication device to use, a number of spatial streams for the second wireless communication device to use, a modulation and coding scheme for the second wireless communication device to use, a first mode of operation to enable for communicating with the first wireless communication device, a second mode of operation to disable for communicating with the first wireless communication device, a traffic identifier-to-link mapping for the second wireless communication device to use, a type of physical layer protocol data unit for the second wireless communication device to use, or any combination thereof,
the first mode of operation comprises an enhanced multi-link single radio mode, an enhanced multi-link multi radio mode, a multi-link multi-radio mode, a multi-link single radio mode, a multi-primary channel mode, spatial multiplexing power save mode, or a packet repetition mode that indicates a repetition of the one or more frames on a link between the first wireless communication device and the second wireless communication device, a duplication of the one or more frames across a set links between the first wireless communication device and the second wireless communication device, or any combination thereof, and
the second mode of operation comprises the enhanced multi-link single radio mode, the enhanced multi-link multi radio mode, the multi-link multi-radio mode, the multi-link single radio mode, the multi-primary channel mode, spatial multiplexing power save mode, or the packet repetition mode.

14. The apparatus of claim 1, wherein, to transmit the indication, the processor and memory are operable to cause the apparatus to:
transmit a frame comprising a set of bits, each bit of the set of bits mapping to a respective set of communication parameters for the second wireless communication device to use for communicating with the first wireless communication device or to a respective set of adjustments to the first set of communication parameters,
the indication being for the second wireless communication device to use the second set of communication parameters in accordance with a value of a first bit of the set of bits that maps to the second set of communication parameters or to a first set of adjustments to the first set of communication parameters used to generate the second set of communication parameters.

15. The apparatus of claim 14, wherein the processor and memory are further operable to cause the apparatus to:
communicate one or more second frames with the second wireless communication device to negotiate a respective mapping of each bit to the respective set of communication parameters or to the respective set of adjustments.

16. The apparatus of claim 15, wherein the processor and memory are further operable to cause the apparatus to:
establish a link with the second wireless communication device in accordance with a capability of the first wireless communication device to negotiate the respective mapping and a capability of the second wireless communication device to negotiate the respective mapping.

17. The apparatus of claim 1, wherein, to transmit the indication, the processor and memory are operable to cause the apparatus to:
transmit the indication via aggregated control (A-Control) signaling, a block acknowledgement frame, or an action frame.

18. The apparatus of claim 1, wherein the processor and memory are further operable to cause the apparatus to:
receive, from the second wireless communication device, a request to trigger the second wireless communication device to transmit one or more second frames to the first wireless communication device, the request comprising a third set of communication parameters associated with transmitting the one or more second frames to the first wireless communication device; and
transmit, to the second wireless communication device and in accordance with the request, a trigger frame that triggers the second wireless communication device to transmit the one or more second frames to the first wireless communication device.

19. The apparatus of claim 18, wherein the processor and memory are further operable to cause the apparatus to:
receive, from the second wireless communication device, the one or more second frames in accordance with the trigger frame triggering the second wireless communication device to transmit the one or more second frames in accordance with the third set of communication parameters.

20. The apparatus of claim 1, wherein the second set of communication parameters is associated with communicating with the first wireless communication device via a first link between the first wireless communication device and the second wireless communication device, and wherein, to transmit the indication, the processor and memory are operable to cause the apparatus to:
transmit the indication via a second link different than the first link.

21. The apparatus of claim 1, wherein:
the first wireless communication device is a first access point (AP) multi-link device (MLD), a first AP station (STA), a first non-AP MLD, a first non-AP STA, or a combination thereof, and
the second wireless communication device is a second AP MLD, a second non-AP MLD, a second AP STA, a second non-AP STA, or a combination thereof.

22. An apparatus for wireless communications at a second wireless communication device, comprising:
a processor; and
memory coupled with the processor, the processor and memory operable to cause the apparatus to:
communicate with a first wireless communication device using a first set of communication parameters;
receive, from the first wireless communication device responsive to a determination that the communicating using the first set of communication parameters fails to satisfy one or more criteria, an indication for the second wireless communication device to use a second set of communication parameters for communicating with the first wireless communication device; and
communicate one or more frames with the first wireless communication device subsequent to receiving the indication.

23. The apparatus of claim 22, wherein, to receive the indication, the processor and memory are operable to cause the apparatus to:
receive a frame that comprises a recommendation that the second wireless communication device use the second set of communication parameters to communicate with the first wireless communication device.

24. The apparatus of claim 22, wherein, to receive the indication, the processor and memory are operable to cause the apparatus to:
receive a request for the second wireless communication device to adjust the first set of communication parameters, the second set of communication parameters being the adjusted first set of communication parameters.

25. The apparatus of claim 22, wherein, to receive the indication, the processor and memory are operable to cause the apparatus to:
receive a request for the second wireless communication device to activate one or more links for communicating with the first wireless communication device using the second set of communication parameters, the request comprising the second set of communication parameters.

26. The apparatus of claim 22, wherein the processor and memory are further operable to cause the apparatus to:
transmit, to the first wireless communication device in response to the indication, a second indication of a confirmation of a usage, by the second wireless communication device, of the second set of communication parameters for communicating with the first wireless communication device, the one or more frames communicated in accordance with the second set of communication parameters in accordance with the confirmation; or
transmit, to the first wireless communication device in response to the indication, a third indication of a rejection, by the second wireless communication device, to use the second set of communication parameters for communicating with the first wireless communication device, the one or more frames communicated in accordance with the first set of communication parameters.

27. The apparatus of claim 22, wherein:
the second set of communication parameters comprises at least one of a bandwidth for the second wireless communication device to use, a number of spatial streams for the second wireless communication device to use, a modulation and coding scheme for the second wireless communication device to use, a first mode of operation to enable for communicating with the first wireless communication device, a second mode of operation to disable for communicating with the first wireless communication device, a traffic identifier-to-link mapping for the second wireless communication device to use, a type of physical layer protocol data unit for the second wireless communication device to use, or any combination thereof,
the first mode of operation comprises an enhanced multi-link single radio mode, an enhanced multi-link multi radio mode, a multi-link multi-radio mode, a multi-link single radio mode, a multi-primary channel mode, spatial multiplexing power save mode, or a packet repetition mode that indicates a repetition of the one or more frames on a link between the first wireless communication device and the second wireless communication device, a duplication of the one or more frames across a set links between the first wireless communication device and the second wireless communication device, or any combination thereof, and
the second mode of operation comprises the enhanced multi-link single radio mode, the enhanced multi-link multi radio mode, the multi-link multi-radio mode, the multi-link single radio mode, the multi-primary channel mode, spatial multiplexing power save mode, or the packet repetition mode.

28. The apparatus of claim 22, wherein the processor and memory are further operable to cause the apparatus to:
transmit, to the first wireless communication device, a request to trigger the second wireless communication device to transmit one or more second frames to the first wireless communication device, the request comprising a third set of communication parameters associated with transmitting the one or more second frames to the first wireless communication device; and
receive, from the first wireless communication device and in accordance with the request, a trigger frame that triggers the second wireless communication device to transmit the one or more second frames to the first wireless communication device.

29. A method for wireless communications at a first wireless communication device, comprising:
monitoring communication with a second wireless communication device via one or more links between the first wireless communication device and the second wireless communication device, the second wireless communication device using a first set of communication parameters for communicating with the first wireless communication device;
transmitting, to the second wireless communication device responsive to a determination that the communication using the first set of communication parameters fails to satisfy one or more criteria, an indication for the second wireless communication device to use a second set of communication parameters for communicating with the first wireless communication device, the second set of communication parameters being different from the first set of communication parameters; and
communicating one or more frames with the second wireless communication device subsequent to transmitting the indication.

30. A method for wireless communications at a second wireless communication device, comprising:
communicating with a first wireless communication device using a first set of communication parameters;
receiving, from the first wireless communication device responsive to a determination that the communicating using the first set of communication parameters fails to satisfy one or more criteria, an indication for the second wireless communication device to use a second set of communication parameters for communicating with the first wireless communication device; and
communicating one or more frames with the first wireless communication device subsequent to receiving the indication.
